(19) United States
(12) Patent Application Publication
(10) Pub. No.: US 2025/0346724 A1
(43) Pub. Date: Nov. 13, 2025

(54) POLYOLEFIN MIMIC POLYESTER COPOLYMERS

(71) Applicant: SABIC Global Technologies B.V., Bergen Op Zoom (NL)

(72) Inventors: Sivadinarayana CHINTA, Bangalore (IN); Alexander STANISLAUS, Bangalore (IN); Girish KORIPELLY, Bangalore (IN); Robbert DUCHATEAU, Bangalore (IN); Kaiwalya SABNIS, Bangalore (IN); Pankaj Singh GAUTAM, Bangalore (IN); Ganesh KANNAN, Bangalore (IN); Ravichander NARAYANASWAMY, Bangalore (IN); Lidia JASINSKA-WALC, Bangalore (IN)

(21) Appl. No.: 18/554,458

(22) PCT Filed: Apr. 8, 2022
(86) PCT No.: PCT/EP2022/059388

§ 371 Date: Oct. 6, 2023

(30) Foreign Application Priority Data
Apr. 8, 2021 (EP) 21167511.1

(51) Int. Cl. C08G 81/02; C08G 77/442; C08J 11/14; C08J 11/24

(52) U.S. Cl. CPC C08G 81/027; C08G 77/442; C08J 11/14; C08J 11/24; C08J 2353/00; C08J 2383/10

(57) ABSTRACT

A copolymer, methods of making the polymer, methods of recycling the polymer and compositions including the polymer are described. The copolymer, can contain repeating units of Formula (I), and repeating units of Formula (11), where X is an aliphatic group for each of Formulas (I) and (II); Z is a first polyolefin group containing at least 45 carbon atoms, preferably 45 to 1,000 carbon atoms, and has a degree of saturation 98 to 100%; Z′ is an aliphatic group; the structure of Z is different than Z′, and wherein Formula (I) or Formula (11), or both, comprise 0.01 to 40 ester groups per 1,000 backbone carbon atoms.

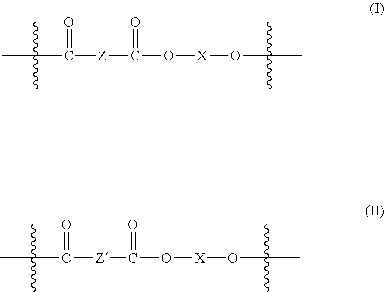

### BACKGROUND OF THE INVENTION

### A. Field of the Invention

The invention generally relates to chemically recyclable polymers.

### B. Description of Related Art

Polyolefins have multiple industrial uses. Polyolefins such as polyethylene and polypropylene constitute the largest volume of synthetic plastic produced worldwide. Polyolefins are used in wide variety of materials, such as films, sheets, foams, fibers, toys, bottles, containers, furniture, electronic parts, and plumbing materials.

An issue with polyolefins is their poor chemical recyclability back to their respective building blocks or monomeric units. For example, the chemical recycling efficiency back to polyolefin building blocks starting from waste plastic is about 40-50%. One reason for this is the chemical recycling process can produce unwanted by-products like aromatics, methane, coke, etc. This means full recycling circularity may not be possible to achieve in the current recycling processes with the polymers currently in use.

### SUMMARY OF THE INVENTION

A discovery has been made that provides a solution to at least some of the problems that may be associated with the chemical recyclability of polymers such as polyolefins. In one aspect, the discovery can include providing polyester copolymers that have polyolefin like properties (e.g., crystallinity, melt temperature (Tₘ), etc.), that can readily be recycled to their respective building blocks. This can increase the chemical recycling efficiency when compared with current polyolefin polymers. In one aspect, it is believed that polyester copolymers, containing at least one block containing less than 40, such as 0.01 to 40 ester groups per 1,000 backbone carbon atoms, and having relatively high degree of saturation, can provide polyolefin like properties. Copolymers of the present invention can readily be recycled to the monomers forming the polymer.

One aspect is directed to a copolymer. The copolymer can contain repeating units of Formula I, and repeating units of Formula II:

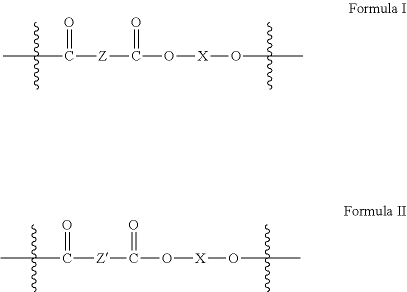

Z can be a polyolefin group. In some aspects, Z can contain at least 45 carbon atoms, and can have a degree of saturation 97 to 100%, such as 98 to 100%. In some aspects, Z can contain 45 to 1,000 carbon atoms, such as 50 to 800 carbon atoms, such as 60 to 600 carbon atoms. In some aspects, Z can have a degree of branching (DB) of 0 to 50%. In some aspects, Z has a DB of 0 to 5%. In some aspects, Z has a DB of 5 to 50%. A polyolefin group of Z, can be a polyolefin with one H missing at each of the two ends of the polyolefin backbone chain, where the valency of the terminal carbons are satisfied by bonding with the “—COO—” groups at the two sides of Z. In some aspects, Z can be a linear polyolefin group. In some aspects, Z can be a branched polyolefin group, having a DB of 0.01 to 50%. In some aspects, Z can contain C₁ to C₁₀ hydrocarbon branches. In some aspects, Z can contain C₁ to C₁₀ alkyl group branches. In some aspects, the polyolefin group of Z can be a polyethylene, polypropylene, poly(ethylene-propylene), or poly(ethylene-co-α-olefin) group. In some aspects, the poly(ethylene-co-α-olefin) group of Z can be poly(ethylene-co-1-butene), poly(ethylene-co-1-hexene), or poly(ethylene-co-1-octene) group. In some aspects, Z can be a linear polyethylene group. In some aspects, Z can be a branched polyethylene group containing C₁ to C₁₀ alkyl group branches, and a DB of 0.01 to 50%. In some aspects, branched polyethylene group of Z can have a DB of 0.01 to 5%. In some aspects, branched polyethylene group of Z can have a DB of 5 to 50%. In some aspects, Z can be an atactic, isotactic, or syndiotactic polypropylene group. In certain aspects, Z can vary randomly between the repeating units of Formula I. In certain aspects, the number of carbon atoms and/or DB of the Z group, such as a polyolefin group of Z, can vary randomly between the repeating units of Formula I. In certain aspects, i) average number of carbon atoms in the Z groups of the polymer can be 45 to 1000, such as 50 to 800, such as 60 to 600, ii) the Z groups of the polymer can have a polydispersity index of 1.5 to 4, preferably 1.5 to 3, more preferably 1.5 to 2.5, and/or iii) the average DB of the Z groups of the polymer can be 0 to 50 mol. %. In certain aspects, Z does not vary between the repeating units of Formula I.

The structure of Z can be different than Z′. Z′ can be an aliphatic group. In some aspects, Z′ can have a degree of saturation 97 to 100%, such as 98 to 100%. In some aspects, Z′ can contain 1 to 1,000 carbon atoms, such as 5 to 800 carbon atoms, such as 10 to 600 carbon atoms. In some aspects, Z′ can have a degree of branching (DB) 0 to 50%. In some aspects, Z′ has a DB of 0 to 5%. In some aspects, Z′ has a DB of 5 to 50%. In some aspects, Z′ can be a linear hydrocarbon. In some aspects, Z′ can be a branched hydrocarbon. In some aspects, Z′ can be a polyolefin group, and can contain 45 to 1,000 carbon atoms, such as 50 to 800 carbon atoms, such as 60 to 600 carbon atoms. A polyolefin group of Z′, can be a polyolefin with one H missing at each of the two ends of the polyolefin backbone chain, where the valency of the terminal carbons are satisfied by bonding with the “—COO—” groups at the two sides of Z′. In some aspects, Z′ can be a linear polyolefin group. In some aspects, Z′ can be a branched polyolefin group, having a DB of 0.01 to 50%. In some aspects, Z′ can be a branched polyolefin group having a DB of 0.01 to 5%. In some aspects, Z′ can be a branched polyolefin group having a DB of 5 to 50%. In some aspects, polyolefin group of Z′ can contain C₁ to C₁₀ hydrocarbon branches. In some aspects, polyolefin group of Z′ can contain C₁ to C₁₀ alkyl group branches. In some aspects, the polyolefin group of Z′ can be a polyethylene, polypropylene, poly(ethylene-co-propylene), or poly(ethylene-co-α-olefin) group. In some aspects, the poly(ethylene-co-α-olefin) group of Z′ can be a poly(ethylene-co-1-butene), poly(ethylene-co-1-hexene), or poly(ethylene-co-1-octene) group. In some aspects, Z′ can be a linear polyethylene group. In some aspects, Z′ can be a branched polyethylene group containing C₁ to C₁₀ alkyl group branches, and a DB of 0.01 to 50%, such as 0.01 to 5%, or 5 to 50%. In some aspects, Z′ can be an atactic, isotactic, or syndiotactic polypropylene group. In certain aspects, Z′ can be a polyolefin group and vary randomly between the repeating units of Formula II. In certain aspects, number of carbon atoms and/or DB of the polyolefin Z′ groups can vary randomly between the repeating units of Formula II. In certain aspects, i) average number of carbon atoms in the polyolefin Z′ groups of the polymer can be 45 to 1000, such as 50 to 800, such as 60 to 600, ii) the polyolefin Z′ groups of the polymer can have a polydispersity index of 1.5 to 4, preferably 1.5 to 3, more preferably 1.5 to 2.5, and/or iii) the average DB of the polyolefin Z′ groups of the polymer can be 0 to 50 mol. %. In certain aspects, polyolefin Z′ groups do not vary between the repeating units of Formula II.

In some aspects, Z′ can be a polyether group. A polyether group can be a polyether with one H missing at each of the two ends of the polyether backbone chain, where the valency of the terminal carbons are satisfied by bonding with the “—COO—” groups at the two sides of Z′. The polyether group can contain 45 to 1,000 atoms (e.g., carbon and oxygen atoms in total) in the polymer backbone. The polyether can be a linear or a branched polyether. In some aspects, Z′ can be a branched polyether group, having a DB of 0.01 to 50%. The branched polyether can contain C₁ to C₁₀ hydrocarbon branches. In some aspects, the branched polyether can contain C₁ to C₁₀ alkyl group branches. In some aspects, Z′ can be poly(ethylene oxide), poly(ethylene oxide-co-propylene oxide), poly(ethylene oxide-block-propylene oxide), poly(propylene oxide) or poly(tetramethylene oxide). In certain aspects, Z′ can be a polyether group and vary randomly between the repeating units of Formula II. In certain aspects, number of carbon and oxygen atoms and/or DB of the polyether Z′ groups can vary randomly between the repeating units of Formula II. In certain aspects, i) average number of carbon and oxygen atoms (in total) in the polyether Z′ groups of the polymer can be 45 to 1000, such as 50 to 800, such as 60 to 600, ii) the polyether Z′ groups of the polymer can have a polydispersity index of 1.01 to 2.0, preferably 1.1 to 1.5 and/or iii) the average DB of the polyether Z′ groups of the polymer can be 0 to 50 mol. %.

In some aspects, Z′ can be a polydimethylsiloxane group. A polydimethylsiloxane group can be a polydimethylsiloxane with one H missing at each of the two ends of the polydimethylsiloxane backbone chain, where the valency of the terminal siloxane are satisfied by bonding with the “—COO—” groups at the two sides of Z′. The polydimethylsiloxane group can contain 45 to 1,000 atoms (e.g., silicon and oxygen atoms in total) in the polydimethylsiloxane group backbone. In some aspects Z′ can be hydroxy terminated poly(dimethylsiloxane), hydroxy propyl terminated poly(dimethylsiloxane or bis(hydroxyalkyl) terminated poly(dimethylsiloxane). In certain aspects, Z′ can be a polydimethylsiloxane group and vary randomly between the repeating units of Formula II. In certain aspects, number of atoms (e.g., silicon and oxygen atoms in total) in the polydimethylsiloxane group backbone of the polydimethylsiloxane Z′ groups can vary randomly between the repeating units of Formula II. In certain aspects, i) average number of atoms in the polydimethylsiloxane group backbone of the polydimethylsiloxane Z′ groups of the polymer can be 45 to 1000, and/or the polydimethylsiloxane Z′ groups in the polymer can have a PDI of 1.01 to 4.

In some aspects, Z′ can be a polystyrene, styrene-butadiene copolymer, polybutadiene group, or substituted polybutadiene group. In some aspects, the substituted polybutadiene group can be polyisoprene group. In some aspects, the polystyrene, styrene-butadiene copolymer, polybutadiene group can contain at least 45 carbon atoms, and can have a degree of saturation of the main chain of 60 to 100%, such as 75 to 100%. In some aspects, Z′ can contain 45 to 1,000 carbon atoms, such as 50 to 800 carbon atoms, such as 60 to 600 carbon atoms. A polystyrene or styrene-butadiene copolymer or polybutadiene group of Z′, can be a polystyrene or styrene-butadiene copolymer or polybutadiene with one H missing at each of the two ends of the polystyrene or styrene-butadiene copolymer or polybutadiene backbone chain, where the valency of the terminal carbons are satisfied by bonding with the “—COO—” groups at the two sides of Z′. In some aspects, the polystyrene or styrene-butadiene copolymer or polybutadiene group of Z′ can be a polystyrene, polybutadiene, random poly(styrene-co-butadiene), poly(styrene-block-polybutadiene) diblock copolymer or poly(styrene-block-polybutadiene-block-styrene) triblock copolymer group. In certain aspects, Z′ can be a polystyrene, styrene-butadiene copolymer or polybutadiene group and can vary randomly between the repeating units of Formula II. In certain aspects, number of carbon atoms in the polystyrene, styrene-butadiene copolymer or polybutadiene Z′ groups can vary randomly between the repeating units of Formula II. In certain aspects, i) average number of carbon atoms in the polystyrene, styrene-butadiene copolymer or polybutadiene Z′ groups can be 45 to 1000 and/or the polystyrene, styrene-butadiene copolymer or polybutadiene Z′ groups in the polymer can have a PDI of 1.01 to 2, preferably 1.05 to 1.5.

In certain aspects, Z′ groups do not vary between the repeating units of Formula II.

X in each of Formula I and Formula II can independently be an aliphatic group. X in each of Formula I and Formula II can independently contain up to 1000 carbon atoms. In some aspects, X in each of Formula I and Formula II can independently be a linear hydrocarbon. In some aspects, X in each of Formula I and Formula II can independently be a branched hydrocarbon. In some aspects, X in each of Formula I and Formula II can independently be a polyolefin group. A polyolefin group of X can be a polyolefin with one H missing at each of the two ends of the polyolefin backbone chain, where the valency of the terminal carbons are satisfied by bonding with the “—O—” groups at the two sides of X. In some aspects, X in each of Formula I and Formula II can independently be a linear polyolefin group. In some aspects, X in each of Formula I and Formula II can independently be a branched polyolefin group having a DB of 0.01 to 50%. In some aspects, X in each of Formula I and Formula II can independently contain C₁ to C₁₀ hydrocarbon branches. In some aspects, X in each of Formula I and Formula II can independently be a polyethylene, poly(ethylene-propylene), poly(α-olefin), poly(α-olefin-co-ethylene), or poly(ethylene-co-α-olefin) group. In certain aspects, X in each of Formula I and Formula II can independently be a poly(ethylene-co-1-butene), poly(ethylene-co-1-hexene), or poly(ethylene-co-1-octene) group. In some aspects, X in each of Formula I and Formula II can independently be a polypropylene group, or a polybutylene group, or a poly(propylene-co-ethylene) group. In some aspects, X in each of Formula I and Formula II can independently be an atactic, isotactic, or syndiotactic polypropylene group. In some aspects, X in each of Formula I and Formula II can independently be a random poly(propylene-co-ethylene) group. In certain aspects, X in Formula I can vary randomly between the repeating units of Formula I. In certain aspects, i) number of carbon atoms in the X groups can vary randomly between the repeating units of Formula I or iii) the DB of the X groups can vary randomly between the repeating units of Formula I. In certain aspects, X does not vary between the repeating units of Formula I. In certain aspects, X in Formula I can vary randomly between the repeating units of Formula II. In certain aspects, i) the number of carbon atoms in the X groups can vary randomly between the repeating units of Formula II or iii) the DB of the X groups can vary randomly between the repeating units of Formula II. In certain aspects, X does not vary between the repeating units of Formula II.

In certain aspects, X in each of Formula I and Formula II can independently contain 45 to 1000 carbon atoms. In certain aspects, X in each of Formula I and Formula II can independently be a C₁ to C₄₄ aliphatic group. In some particular aspects, X in each of Formula I and Formula II can independently be a C₁ to C₂₀ aliphatic group. For example, X can have the same or a different structure in each of Formula I and Formula II. In some aspects, X can have the same structure in Formula I and Formula II. In some aspects, X can have different structures in Formula I and Formula II. In some aspects, X can independently be a linear or branched, and substituted or unsubstituted hydrocarbon in each of Formula I and Formula II. In some aspects, X can independently have the formula of (1), (2), (3), (4), or (5), in each of Formula I and Formula II:

In some aspects, X in each of Formula I and Formula II can independently be a linear or branched, and substituted or unsubstituted hydrocarbon. In some aspects, X in each of Formula I and Formula II can independently have the formula of (1), (2), (3), (4), or (5):

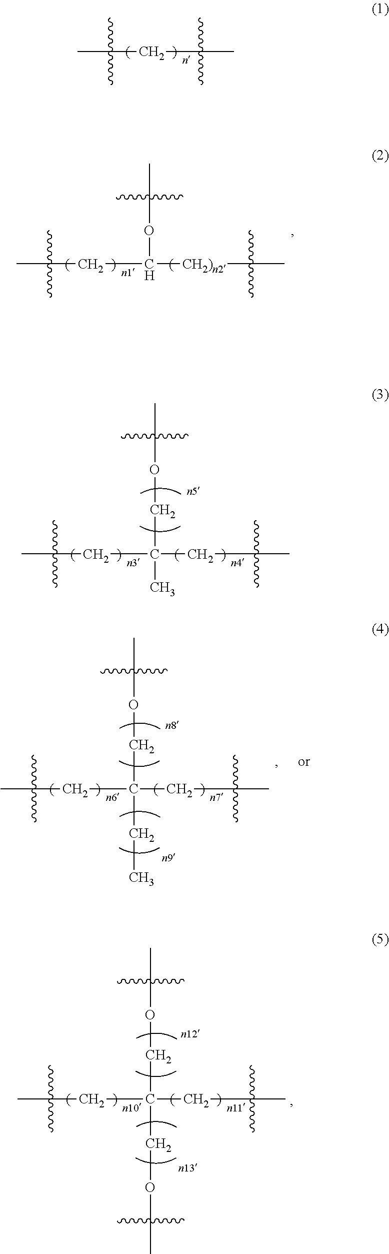

combination thereof,
wherein n′ in formula (1) is an integer from 1 to 1000 and denotes number of repeat units. In certain aspects, n′ can be an integer from 1 to 15. n1′, n2′, n3′, n4′, n5′, n6′, n7′, n8′, n9′, n10′, n11′, n12′, and n13′, are independently an integer from 1 to 10, and denote number of repeat units. In some aspects, n1′, n2′, n3′, n4′, n5′, n6′, n7′, n8′, n9′, n10′, n11′, n12′, and n13′, are independently an integer from 1 to 5.

In certain aspects, the copolymer can contain i) repeating units of a first unit having the formula of Formula I, and ii) repeating units of a second unit having the formula of Formula I, wherein X of the first unit can have a different formula than the X of the second unit. In certain aspects, X of the first unit can be a linear hydrocarbon, and the X of the second unit can contain one or more side functional groups. In some aspects, the functional group can be oxy group. The second unit can introduce branching in polymer. The second unit can be bonded to three or more monomers. In some aspects, X of the first unit has the chemical formula of Formula (1), and X of the second unit has the chemical formula of Formula (2), (3), (4) or (5). The Z of the first unit and the second unit can be same or different, e. g. can have same or different chemical formula. In some aspects, Z of the first unit and the second unit can have the same formula. In certain aspects, the ratio of mol. % of the first unit and second unit in the polymer can be 9:1 to 999:1, or equal to any one of, at least any one of, or between any two of 9:1, 10:1, 15:1, 20:1, 25:1, 30:1, 35:1, 40:1, 45:1, 50:1, 55:1, 60:1, 65:1, 70:1, 75:1, 80:1, 85:1, 90:1, 95:1, 100:1, 200:1, 300:1, 400:1, 500:1, 600:1, 700:1, 800:1, 900:1, and 999:1. In certain aspects, the copolymer can contain i) repeating units of a third unit having the formula of Formula II, and ii) repeating units of a fourth unit having the formula of Formula II, wherein X of the third unit can have a different formula than the X of the fourth unit. In certain aspects, X of the third unit can be a linear hydrocarbon, and the X of the fourth unit can contain one or more side functional groups. In some aspects, the functional group can be oxy group. The fourth unit can introduce branching in polymer. The fourth unit can be bonded to three or more monomers. In some aspects, X of the third unit has the chemical formula of Formula (1), and X of the fourth unit has the chemical formula of Formula (2), (3), (4) or (5). The Z′ of the third unit and the fourth unit can be same or different, e. g. can have same or different chemical formula. In some aspects, Z′ of the third unit and the fourth unit can have the same formula. In some aspects, X of the first unit and the third unit can be same. In some aspects, X of the second unit and the fourth unit can be same. In some aspects, the first units, second units, third units and the fourth units can be arranged in the copolymer randomly. In certain aspects, the ratio of mol. % of the third unit and fourth unit in the polymer can be 9:1 to 999:1, or equal to any one of, at least any one of, or between any two of 9:1, 10:1, 15:1, 20:1, 25:1, 30:1, 35:1, 40:1, 45:1, 50:1, 55:1, 60:1, 65:1, 70:1, 75:1, 80:1, 85:1, 90:1, 95:1, 100:1, 200:1, 300:1, 400:1, 500:1, 600:1, 700:1, 800:1, 900:1, and 999:1.

In some aspects, the number average molecular weight (Mₙ) of the copolymer can be 10,000 to 1,000,000 g/mol, such as 20,000 to 500,000 g/mol, such as 40,000 to 200,000 g/mol. The Mₙ can be determined as the polyethylene equivalent molecular weight by high temperature size exclusion chromatography performed at 160° C. in trichlorobenzene using polyethylene standards. In some aspects, the polymer can have a polydispersity index (PDI), of 1.5 to 4, preferably 1.8 to 3. In some aspects, the copolymer can contain at least one amorphous block, and at least one semi-crystalline block. In some aspects, the block copolymer can contain at least two amorphous blocks, wherein the glass transition temperature (T_{g}) of the two blocks can be different. In some aspects, the units of Formula I and units of Formula II can be arranged in the copolymer randomly, alternatively, or in blocks. In some particular aspects, the units of Formula I and units of Formula II can be arranged in the copolymer randomly. In certain aspects, the copolymer can be a statistical copolymer.

In some aspects, the Z and Z′ groups in the copolymer can such that melt temperatures (Tₘ) of a polymer, such as a homopolymer, formed by the Z groups of the copolymer, and a polymer, such as a homopolymer, formed by the Z′ groups of the copolymer, can differ by at least 40° C., such as 40° C. to 180° C., such as 85° C. to 170° C., such as 90° C. to 150° C. In some aspects, the Z and Z′ groups in the copolymer can be such that glass transition temperature (T_{g}) of a polymer, such as a homopolymer, formed by the Z groups of the copolymer, and a polymer, such as a homopolymer, formed by the Z′ groups of the copolymer, can differ by at least 5° C., such as by at least 10° C., such as by at least 20° C., such as by at least 30° C., such as by at least 40° C., such as by at least 50° C., such as by at least 100° C., such as at least by 140° C. In some aspects, the Z and Z′ groups in the copolymer can be such that crystallinity at room temperature of a polymer, such as a homopolymer, formed by the Z groups of the copolymer, and a polymer, such as a homopolymer, formed by the Z′ groups of the copolymer, can differ by at least 5%, such as by at least 10%, such as by at least 20%, such as by at least 30%, such as by at least 40%. In certain aspects, a polymer, such as a homopolymer, formed by the Z groups of the copolymer, and a polymer, such as a homopolymer, formed by the Z′ groups of the copolymer can be semi-crystalline at room temperature. In certain aspects, a polymer, such as a homopolymer, formed by the Z groups of the copolymer, and the polymer, such as a homopolymer, formed by the Z′ groups of the copolymer can be amorphous at room temperature. In certain aspects, a polymer, such as a homopolymer, formed by the Z groups of the copolymer can be amorphous, and a polymer, such as a homopolymer, formed by the Z′ groups of the copolymer can be semi-crystalline at room temperature. In certain aspects, a polymer, such as a homopolymer, formed by the Z groups of the copolymer can be semi-crystalline, and the polymer, such as a homopolymer, formed by the Z′ groups of the copolymer can be amorphous at room temperature.

In certain aspects, the Formula I can be Formula III, and the Formula II can be Formula IV, and the copolymer can contain repeating units of Formula III, and repeating units of Formula IV

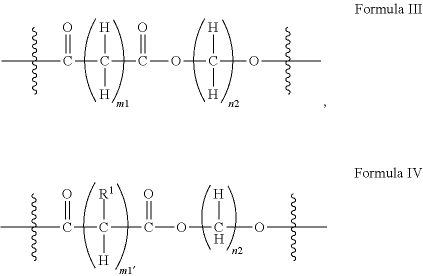

wherein i) n2 can independently be an integer from 0 to 15, such as 1, 2, 3, 4, 5, 6, 7, 8, 9, 10, 11, 12, 13, 14 or 15, for each of Formula III and IV, and denotes number of repeat units; ii) m1 can be an integer from 45 to 1000, or equal to any one of, at least any one of, or between any two of 45, 50, 60, 70, 80, 90, 100, 150, 200, 250, 300, 350, 400, 450, 500, 550, 600, 650, 700, 750, 800, 850, 900, 950 and 1000, and denotes number of repeat units; iii) m1′ can be an integer from 45 to 800, or equal to any one of, at least any one of, or between any two of 45, 50, 60, 70, 80, 90, 100, 150, 200, 250, 300, 350, 400, 450, 500, 550, 600, 650, 700, 750, 800, 850, 900, 950 and 1000, and denotes number of repeat units; iv) R¹ can be —H or a C₁ to C₁₀ alkyl group, and can vary independently between H and the C₁ to C₁₀ alkyl group in the repeating units —CHR¹—; v) the —(CHR¹)_{m1′}— group can have a DB of 5% or higher, such as 5 to 50%, or equal to any one of, at least any one of, or between any two of 5, 6, 7, 8, 9, 10, 12, 15, 20, 25, 30, 35, 40, 45 and 50%; or any combinations thereof. In some aspects, n2 can be 2 for each of Formula III and IV. In some aspects, R¹ can be —H or —CH₃. In some aspects, R¹ can be —H or —CH₂CH₃. In some aspects, R¹ can be —H or a C₃ alkyl group. In some aspects, R¹ can be —H or a C₄ alkyl group. In some aspects, R¹ can be —H or a C₅ alkyl group. In some aspects, R¹ can be —H or a C₆ alkyl group. In some aspects, R¹ can be —H or a C₇ alkyl group. In some aspects, R¹ can be —H or a C₈ alkyl group. In some aspects, R¹ can be —H or a C₉ alkyl group. In some aspects, R¹ can be —H or a C₁₀ alkyl group. In certain aspects, m1 can vary randomly between the repeating units of Formula III, and/or average of mis in the polymer can be 60 to 600. In certain aspects, m1 does not vary between the repeating units of Formula III. In certain aspects, m1′ can vary randomly between the repeating units of Formula IV, and/or average of m1's in the polymer can be 45 to 800. In certain aspects, m1′ does not vary between the repeating units of Formula IV. In certain aspects, DB of the —(CHR¹)_{m1′}— group can vary randomly between the repeating units of Formula IV, and/or the average DB of the —(CHR¹)_{m1′}— groups of the polymer can be 5 to 50%. In certain aspects, DB of the —(CHR¹)_{m1′}— group between the repeating units of Formula IV does not vary.

In certain aspects, the Formula I can be Formula V, and the Formula II can be Formula VI, and the copolymer can contain repeating units of Formula V, and repeating units of Formula VI,

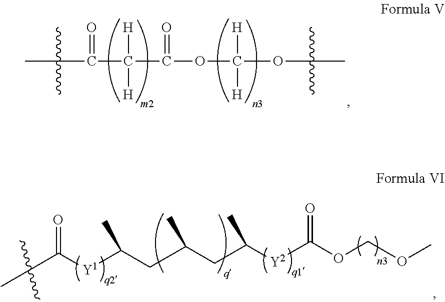

wherein i) n3 can independently be an integer from 0 to 15, such as 1, 2, 3, 4, 5, 6, 7, 8, 9, 10, 11, 12, 13, 14 or 15, for each of Formulas V and VI, and denotes number of repeat units; ii) m2 can be an integer from 60 to 600, or equal to any one of, at least any one of, or between any two of 60, 70, 80, 90, 100, 150, 200, 250, 300, 350, 400, 450, 500, 550, and 600, and denotes number of repeat units; iii) q′ can be an integer from 25 to 200, and 50 to 125, or equal to any one of, at least any one of, or between any two of 25, 30, 40, 50, 60, 70, 80, 90, 100, 125, 150, 175 and 200, and denotes number of repeat units; or any combinations thereof. Y¹ and Y² are independently a C1-C10 hydrocarbons and Y¹ and Y² can be the same or different. q1′ and q2′ are integer, and can be independently 0 or 1. In some aspects, Y1 and Y2 can independently be —(CH₂)_{n″}—, or —(CH₂)_{n1″}—CH═CH—(CH₂)_{n2″}—. n″ can be an integer from 1 to 10. n1″ and n2″ can independently be and integer from 0 to 4. In some aspects, n3 can be 2 for each of Formula V and VI. In certain aspects, m2 can vary randomly between the repeating units of Formula V, and/or the average of m2s in the polymer can be 60 to 600, or equal to any one of, at least any one of, or between any two of 60, 70, 80, 90, 100, 150, 200, 250, 300, 350, 400, 450, 500, 550, and 600. In certain aspects, m2 does not vary between the repeating units of Formula V. In certain aspects, q′ can vary randomly between the repeating units of Formula VI, and/or average of q's in the polymer can be 25 to 200, or equal to any one of, at least any one of, or between any two of 25, 30, 40, 50, 60, 70, 80, 90, 100, 125, 150, 175 and 200. In certain aspects, q′ does not vary between the repeating units of Formula VI.

In certain aspects, the Formula I can be Formula VII, and the Formula II can be Formula VIII, and the copolymer can contain repeating units of Formula VII, and repeating units of Formula VIII

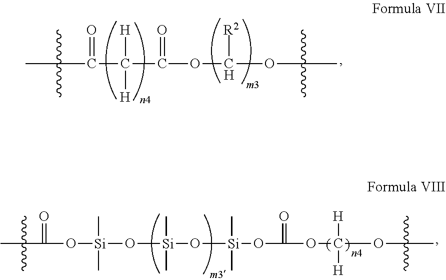

wherein, i) n4 can independently be an integer from 0 to 15, such as 1, 2, 3, 4, 5, 6, 7, 8, 9, 10, 11, 12, 13, 14 or 15, for each of Formulas VII and VIII, and denotes number of repeat units; ii) R² can be —H or a C1 to C10 alkyl group, and varies independently between H and the C1 to C10 alkyl group in the repeating units —CHR²—; iii) the —(CHR²)ₘ₃— group can have a DB of 0.01 to 50%, or equal to any one of, at least any one of, or between any two of 0.01, 0.1, 1, 2, 3, 4, 5, 6, 7, 8, 9, 10, 12, 15, 20, 25, 30, 35, 40, 45 and 50; iv) m3 can be an integer from 45 to 600, or equal to any one of, at least any one of, or between any two of 45, 50, 60, 70, 80, 90, 100, 150, 200, 250, 300, 350, 400, 450, 500, 550, and 600, and denotes number of repeat units; v) m3′ can be an integer from 20 to 497, or equal to any one of, at least any one of, or between any two of 20, 25, 30, 35, 40, 50, 60, 70, 80, 90, 100, 150, 200, 250, 300, 350, 400, 450, and 497, and denotes number of repeat units; or any combinations thereof. In some aspects, n4 can be 2 for each of Formula VII and VIII. In some aspects, R² can be —H or —CH₃. In some aspects, R² can be —H or —CH₂CH₃. In some aspects, R² can be —H or a C3 alkyl group. In some aspects, R² can be —H or a C4 alkyl group. In some aspects, R² can be —H or a C₅ alkyl group. In some aspects, R² can be —H or a C6 alkyl group. In some aspects, R² can be —H or a C7 alkyl group. In some aspects, R² can be —H or a C8 alkyl group. In some aspects, R² can be —H or a C9 alkyl group. In some aspects, R² can be —H or a C10 alkyl group. In certain aspects, m3 can vary randomly between the repeating units of Formula VII, and/or average of m3s in the polymer can be 45 to 600, or equal to any one of, at least any one of, or between any two of 45, 50, 60, 70, 80, 90, 100, 150, 200, 250, 300, 350, 400, 450, 500, 550, and 600. In certain aspects, m3 does not vary between the repeating units of Formula VII. In certain aspects, DB of the —(CHR²)ₘ₃— group can vary randomly between the repeating units of Formula VII, and/or the average DB of the —(CHR²)ₘ₃— groups of the polymer can be 0.01 to 50%, or equal to any one of, at least any one of, or between any two of 0.01, 0.1, 1, 2, 3, 4, 5, 6, 7, 8, 9, 10, 12, 15, 20, 25, 30, 35, 40, 45 and 50%. In certain aspects, DB of the —(CHR²)ₘ₃— group between the repeating units of Formula VII does not vary. In certain aspects, m3′ can vary randomly between the repeating units of Formula VIII, and/or average of m3's in the polymer can be 20 to 497, or equal to any one of, at least any one of, or between any two of 20, 25, 30, 35, 40, 50, 60, 70, 80, 90, 100, 150, 200, 250, 300, 350, 400, 450, and 497. In certain aspects, m3′ does not vary between the repeating units of Formula VIII.

In certain aspects, the Formula I can be Formula IX, and the Formula II can be Formula X, and the copolymer can contain repeating units of Formula IX, and repeating units of Formula X,

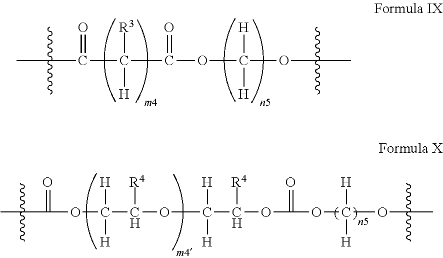

wherein i) n5 can independently be an integer from 0 to 15, such as 1, 2, 3, 4, 5, 6, 7, 8, 9, 10, 11, 12, 13, 14 or 15, for each of Formulas IX and X, and denotes number of repeat units; ii) R³ can be —H or a C₁ to C₁₀ alkyl group, and varies independently between —H and the C₁ to C₁₀ alkyl group in the repeating units —CHR³—; iii) the —(CHR³)ₘ₄— group can have a DB of 0.01 to 50%, or equal to any one of, at least any one of, or between any two of 0.01, 0.1, 1, 2, 3, 4, 5, 6, 7, 8, 9, 10, 12, 15, 20, 25, 30, 35, 40, 45 and 50%; iv) m4 can be an integer from 60 to 600, or equal to any one of, at least any one of, or between any two of 60, 70, 80, 90, 100, 150, 200, 250, 300, 350, 400, 450, 500, 550, and 600, and denotes number of repeat units; v) m4′ can be an integer from 1 to 332, or equal to any one of, at least any one of, or between any two of 1, 5, 10, 15, 20, 25, 30, 35, 40, 50, 60, 70, 80, 90, 100, 150, 200, 250, 300, and 332, and denotes number of repeat units; vi) R⁴ is a C₁ to C₁₀ alkyl group; or any combinations thereof. In some aspects, n5 can be 2 for each of Formula IX and X. In some aspects, R³ can be —H or —CH₃. In some aspects, R³ can be —H or —CH₂CH₃. In some aspects, R³ can be —H or C₃ alkyl group. In some aspects, R³ can be —H or a C₄ alkyl group. In some aspects, R³ can be —H or a C₅ alkyl group. In some aspects, R³ can be —H or a C₆ alkyl group. In some aspects, R³ can be —H or a C₇ alkyl group. In some aspects, R³ can be —H or a C₈ alkyl group. In some aspects, R³ can be —H or a C₉ alkyl group. In some aspects, R³ can be —H or a C₁₀ alkyl group. In certain aspects, m4 can vary randomly between the repeating units of Formula IX, and/or average of m4s in the polymer can be 60 to 600, or equal to any one of, at least any one of, or between any two of 45, 50, 60, 70, 80, 90, 100, 150, 200, 250, 300, 350, 400, 450, 500, 550, and 600. In certain aspects, m4 does not vary between the repeating units of Formula IX. In certain aspects, DB of the —(CHR³)ₘ₄— group can vary randomly between the repeating units of Formula IX, and/or the average DB of the —(CHR³)ₘ₄— groups of the polymer can be 0.01 to 50%, or equal to any one of, at least any one of, or between any two of 0.01, 0.1, 1, 2, 3, 4, 5, 6, 7, 8, 9, 10, 12, 15, 20, 25, 30, 35, 40, 45 and 50%. In certain aspects, DB of the —(CHR³)ₘ₄— group between the repeating units of Formula IX does not vary. In certain aspects, m4′ can vary randomly between the repeating units of Formula X, and/or average of m4's in the polymer can be 1 to 332, or equal to any one of, at least any one of, or between any two of 1, 5, 10, 15, 20, 25, 30, 35, 40, 50, 60, 70, 80, 90, 100, 150, 200, 250, 300, and 332. In certain aspects, m3′ does not vary between the repeating units of Formula VIII.

In certain aspects, the Formula I can be Formula XII, and the Formula II can be Formula XIII, and the copolymer can contain repeating units of Formula XII, and repeating units of Formula XIII,

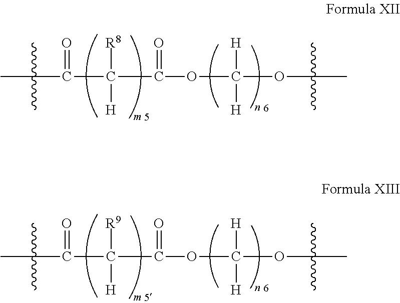

wherein i) n6 can independently be an integer from 0 to 15, such as 1, 2, 3, 4, 5, 6, 7, 8, 9, 10, 11, 12, 13, 14 or 15, for each of Formula XII and XIII, and denotes number of repeat units; ii) m5 can be an integer from 60 to 600, or equal to any one of, at least any one of, or between any two of 45, 50, 60, 70, 80, 90, 100, 150, 200, 250, 300, 350, 400, 450, 500, 550, and 600, and denotes number of repeat units; iii) R⁸ can be —H or a C₁ to C₁₀ alkyl group, and can vary independently between —H and the C₁ to C₁₀ alkyl group in the repeating units —CHR⁸—; iv) the —(CHR⁸)ₘ₅— group can have a DB of 0.01 to less than 5%, or equal to any one of, at most any one of, or between any two of 0.01, 0.1, 0.5, 1, 2, 3, 4, or less than 5%; v) m5′ can be an integer from 5 to 800, or equal to any one of, at least any one of, or between any two of 5, 10, 15, 20, 25, 30, 35, 40, 45, 50, 60, 70, 80, 90, 100, 150, 200, 250, 300, 350, 400, 450, 500, 550, 600, 700, and 800, and denotes number of repeat units; vi) R⁹ can be —H or a C₁ to C₁₀ alkyl group, and can vary independently between —H and the C₁ to C₁₀ alkyl group in the repeating units —CHR⁹—; vii) the —(CHR⁹)ₘ₅′— group can have a DB of 5% or higher, such as 5% to 50%, or equal to any one of, at least any one of, or between any two of 0.01, 0.1, 1, 2, 3, 4, 5, 6, 7, 8, 9, 10, 12, 15, 20, 25, 30, 35, 40, 45 and 50%; or any combinations thereof. In some aspects, n6 can be 2 for each of Formula XII and XIII. In some aspects, the —(CHR⁸)ₘ₅— group can have a DB of 0.01 to 3%. In some aspects, R⁸ can be —H or —CH₃. In some aspects, R⁸ can be —H or —CH₂CH₃. In some aspects, R⁸ can be —H or a C₃ alkyl group. In some aspects, R⁸ can be —H or a C₄ alkyl group. In some aspects, R⁸ can be —H or a C₅ alkyl group. In some aspects, R⁸ can be —H or a C₆ alkyl group. In some aspects, R⁸ can be —H or a C₇ alkyl group. In some aspects, R⁸ can be —H or a C₈ alkyl group. In some aspects, R⁸ can be —H or a C₉ alkyl group. In some aspects, R⁸ can be —H or a C₁₀ alkyl group. In some aspects, R⁹ can be —H or —CH₃. In some aspects, R⁹ can be —H or —CH₂CH₃. In some aspects, R⁹ can be —H or a C₃ alkyl group. In some aspects, R⁹ can be —H or a C₄ alkyl group. In some aspects, R⁹ can be —H or a C₅ alkyl group. In some aspects, R⁹ can be —H or a C₆ alkyl group. In some aspects, R⁹ can be —H or a C₇ alkyl group. In some aspects, R⁹ can be —H or a C₈ alkyl group. In some aspects, R⁹ can be —H or a C₉ alkyl group. In some aspects, R⁹ can be —H or a C₁₀ alkyl group. In certain aspects, m5 can vary randomly between the repeating units of Formula XII, and/or average of m5s in the polymer can be 60 to 600, or equal to any one of, at least any one of, or between any two of 60, 70, 80, 90, 100, 150, 200, 250, 300, 350, 400, 450, 500, 550, and 600. In certain aspects, m5 does not vary between the repeating units of Formula XII. In certain aspects, DB of the —(CHR⁸)ₘ₅— group can vary randomly between the repeating units of Formula XII, and/or the average DB of the —(CHR⁸)ₘ₅— groups of the polymer can be 0.01 to less than 5%, or equal to any one of, at most any one of, or between any two of 0.01, 0.1, 0.5, 1, 2, 3, 4, or less than 5%. In certain aspects, DB of the —(CHR⁸)ₘ₅— group between the repeating units of Formula XII does not vary. In certain aspects, m5′ can vary randomly between the repeating units of Formula XIII, and/or average of m5's in the polymer can be 5 to 800, or equal to any one of, at least any one of, or between any two of 5, 10, 15, 20, 25, 30, 35, 40, 45, 50, 60, 70, 80, 90, 100, 150, 200, 250, 300, 350, 400, 450, 500, 550, 600, 700, and 800. In certain aspects, m5 does not vary between the repeating units of Formula XIII. In certain aspects, DB of the —(CHR⁹)ₘ₅′— group can vary randomly between the repeating units of Formula XIII, and/or the average DB of the —(CHR⁹)ₘ₅′— groups of the polymer can be 5 to 50%, or equal to any one of, at least any one of, or between any two of 5, 6, 7, 8, 9, 10, 12, 15, 20, 25, 30, 35, 40, 45 and 50%.

In certain aspects, the Formula I can be Formula XIV, and the Formula II can be Formula XV or Formula XVI, and the copolymer can contain i) repeating units of Formula XIV, and ii) repeating units of Formula XV or Formula XVI,

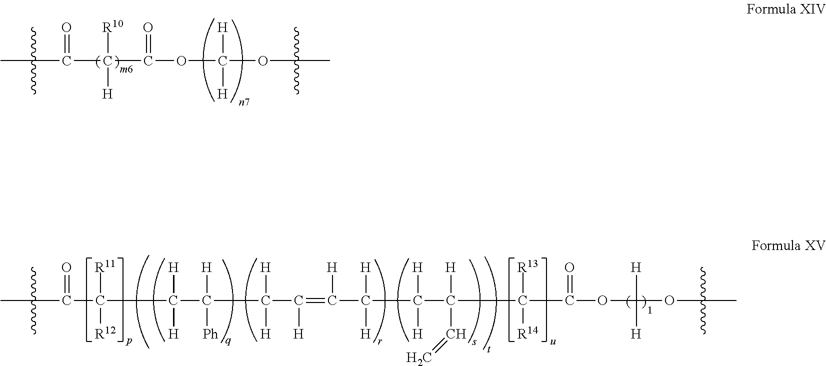

wherein in Formula XV, —CR¹¹R¹²— group and —CR¹³R¹⁴— are linear or branched hydrocarbons, p and u are independently an integer from 1 to 5, such as 1, 2, 3, 4 or 5; q, r, s, t are integers and can be independently chosen such that (q+r/2+s)×2×t≤1000-p-u, and -Ph is a phenyl group. R¹¹ can be —H or a C₁ to C₁₀ alkyl group, and can vary independently between —H and the C₁ to C₁₀ alkyl group in the repeating units —CR¹¹R¹²— group. R² can be —H or a C₁ to C₁₀ alkyl group, and can vary independently between —H and the C₁ to C₁₀ alkyl group in the repeating units —CR¹¹R¹²— group. R³ can be —H or a C₁ to C₁₀ alkyl group, and can vary independently between —H and the C₁ to C₁₀ alkyl group in the repeating units —CR¹³R¹⁴— group. R¹⁴ can be —H or a C₁ to C₁₀ alkyl group, and can vary independently between —H and the C₁ to C₁₀ alkyl group in the repeating units —CR¹³R¹⁴— group.

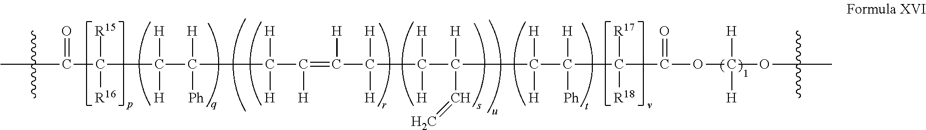

wherein in Formula XVI, —CR¹⁵R¹⁶— group and —CR¹⁷R¹⁸— are linear or branched hydrocarbons, p and v are independently an integer from 1 to 5, such as 1, 2, 3, 4 or 5; q, r, s, t, u are integers and can be independently chosen such that (q+(r/2+s)×u+t)×2<1000-p-v, and -Ph is a phenyl group. R can be —H or a C₁ to C₁₀ alkyl group, and can vary independently between —H and the C₁ to C₁₀ alkyl group in the repeating units —CR¹⁵R¹⁶— group. R¹⁶ can be —H or a C₁ to C₁₀ alkyl group, and can vary independently between —H and the C₁ to C₁₀ alkyl group in the repeating units —CR¹⁵R¹⁶— group. R¹⁷ can be —H or a C₁ to C₁₀ alkyl group, and can vary independently between —H and the C₁ to C₁₀ alkyl group in the repeating units —CR¹⁷R¹⁸— group. R¹⁸ can be —H or a C₁ to C₁₀ alkyl group, and can vary independently between —H and the C₁ to C₁₀ alkyl group in the repeating units —CR¹⁷R¹⁸— group;
wherein i) n7 can independently be an integer from 0 to 15, such as 1, 2, 3, 4, 5, 6, 7, 8, 9, 10, 11, 12, 13, 14 or 15, for each of Formula XIV, XV and XVI, and denotes number of repeat units; ii) m6 can be an integer from 60 to 600, or equal to any one of, at least any one of, or between any two of 60, 70, 80, 90, 100, 150, 200, 250, 300, 350, 400, 450, 500, 550, and 600, and denotes number of repeat units; iii) R¹⁰ can be —H or a C₁ to C₁₀ alkyl group, and can vary independently between H and the C₁ to C₁₀ alkyl group in the repeating units —CHR¹⁰—; and/or iv) the —(CHR¹⁰)ₘ₆— group can have a DB of 0.01 to 50%, or equal to any one of, at least any one of, or between any two of 0.01, 0.1, 1, 2, 3, 4, 5, 6, 7, 8, 9, 10, 12, 15, 20, 25, 30, 35, 40, 45 and 50%. In some aspects, n7 can be 2 for each of Formula XIV, XV and XVI. In some aspects, R¹⁰ can be —H or —CH₃. In some aspects, R¹⁰ can be —H or —CH₂CH₃. In some aspects, R¹⁰ can be —H or a C₃ alkyl group. In some aspects, R¹⁰ can be —H or a C₄ alkyl group. In some aspects, R¹⁰ can be —H or a C₅ alkyl group. In some aspects, R¹⁰ can be —H or a C₆ alkyl group. In some aspects, R¹⁰ can be —H or a C₇ alkyl group. In some aspects, R¹⁰ can be —H or a C₈ alkyl group. In some aspects, R¹⁰ can be —H or a C₉ alkyl group. In some aspects, R¹⁰ can be —H or a C₁₀ alkyl group. In certain aspects, m6 can vary randomly between the repeating units of Formula XIV, and/or average of m6s in the polymer can be 60 to 600, or equal to any one of, at least any one of, or between any two of 60, 70, 80, 90, 100, 150, 200, 250, 300, 350, 400, 450, 500, 550, and 600. In certain aspects, m6 does not vary between the repeating units of Formula XIV. In certain aspects, DB of the —(CHR¹⁰)ₘ₆— group can vary randomly between the repeating units of Formula XIV, and/or the average DB of the —(CHR¹⁰)ₘ₆— groups of the polymer can be 0.01 to 50%, or equal to any one of, at least any one of, or between any two of 0, 0.01, 0.1, 1, 2, 3, 4, 5, 6, 7, 8, 9, 10, 12, 15, 20, 25, 30, 35, 40, 45 and 50%. In certain aspects, DB of the —(CHR¹⁰)ₘ₆— group between the repeating units of Formula XIV does not vary.

Certain aspects are directed to a method for forming a copolymer described herein. The method can include reacting i) a first α,ω-dicarboxylic acid compound having a formula of HOOC—Z—COOH or a ester thereof, and ii) a second α,ω-dicarboxylic acid compound having a formula of HOOC—Z′—COOH or a ester thereof, with a α,ω-dihydroxy compound having a formula of Formula XI.

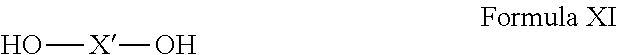

X′ can be an aliphatic group. X′ can contain up to 1000 carbon atoms. In some aspects, X′ can be a linear hydrocarbon. In some aspects, X′ can be a branched hydrocarbon. In some aspects, X′ can be a polyolefin group. A polyolefin group of X′ can be a polyolefin with one H missing at each of the two ends of the polyolefin backbone chain, where the valency of the terminal carbons are satisfied by bonding with the “—O—” groups at the two sides of X′. In some aspects, X′ can be a linear polyolefin group. In some aspects, X′ can be a branched polyolefin group having a DB of 0.01 to 50%. In some aspects, X′ can contain C₁ to C₁₀ hydrocarbon branches. In some aspects, X′ can be a polyethylene, poly(ethylene-propylene), poly(α-olefin), poly(α-olefin-co-ethylene), or poly(ethylene-co-α-olefin) group. In certain aspects, X′ can be a poly(ethylene-co-1-butene), poly(ethylene-co-1-hexene), or poly(ethylene-co-1-octene) group. In some aspects, X′ can be a polypropylene group, or a polybutylene group, or a poly(propylene-co-ethylene) group. In some aspects, X′ can be an atactic, isotactic, or syndiotactic polypropylene group. In some aspects, X′ can be random poly(propylene-co-ethylene) group. In certain aspects, X′ can contain 45 to 1000 carbon atoms. In certain aspects, X′ can be a C₁ to C₄₄ aliphatic group. In some particular aspects, X′ can be a C₁ to C₂₀ aliphatic group. In some aspects, X′ can be a linear or branched, and substituted or unsubstituted hydrocarbon. In some aspects, X′ can have the formula of (1), (6), (7), (8), or (9):

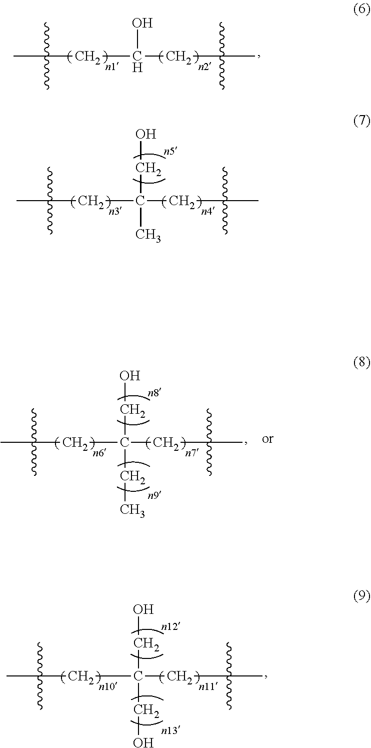

n1′, n2′, n3′, n4′, n5′, n6′, n7′, n8′, n9′, n10′, n11′, n12′, and n13′, are independently an integer from 1 to 5, and denote number of repeat units. Formula (1) is defined above.
wherein n′ in formula (1) is an integer from 1 to 1000, and denotes number of repeat units, and wherein p1 and p2 in formula (9) are independently 0, 1, 2, 3, 4 or 5, and denote number of repeat units. In certain aspects, n′ is an integer from 1 to 15.

In some aspects, the α,ω-dihydroxy compound (e.g., of Formula XI) can be ethylene glycol, 1,3-propanediol, 1,4-butanediol, 1,6-hexanediol, 1,2-cyclohexanediol, 2-butene-1,4-diol, glycerol, trimethalolmethane, trimethalolethane, trimethalolpropane, 3-hydroxymethyl-1,5-pentanediol, pentaerythritol, or any combinations thereof. In some aspects, the ester of the first α,ω-dicarboxylic acid compound and/or second α,ω-dicarboxylic acid compound can independently be a methyl, ethyl and/or propyl ester.

In some aspects, the first α,ω-dicarboxylic acid compound can be oxalic acid, malonic acid, succinic acid, maleic acid, glutaric acid, adipic acid, pimelic acid, suberic acid, azelaic acid, sebacic acid, or any combinations thereof. In some aspects, the second α,ω-dicarboxylic acid compound can be citric acid, aconitic acid, isocitric acid, propane-1,2,3-tricarboxylic acid, pentane-1,3,5-tricarboxylic acid, or any combinations thereof. In some aspects, the diacid can have 45 to 100 carbon atoms (e.g., 45, 50, 55, 60, 65, 70, 75, 85, 90, 95, 100 or any value or range there between) and a diol with less than 6 carbon atoms (e.g. 1, 2, 3, 4, 5, 6 or any value or range there between). A non-limiting example of a diol is ethylene glycol.

In some aspects, a) HO₂C—Z—CO₂H and/or ester thereof, and b) HO₂C—Z′—CO₂H and/or ester thereof, can be reacted with HO—X′—OH (e.g., of Formula XI) at i) a temperature of 90 to 250° C., and/or ii) under inert atmosphere and/or vacuum.

In some aspects, the α,ω-dihydroxy compounds of Formula XI can be reacted with HO₂C—Z—CO₂H and/or ester thereof, and b) HO₂C—Z′—CO₂H and/or ester thereof, in presence of a triacid, tetraacid, and/or polyacid (poly >4) to form branches in the copolymer. The mol. ratio of i) of HO₂C—Z—CO₂H and HO₂C—Z′—CO₂H and ii) triacid, tetraacid and/or polyacid, in the reaction mixture can be 9:1 to 100:1.

In some aspects, the method can include reacting the a) HO₂C—Z—CO₂H and/or ester thereof, and b) HO₂C—Z′—CO₂H and/or ester thereof with i) a first α,ω-dihydroxy compound having the formula of Formula XI, and ii) a second α,ω-dihydroxy compound having the formula of Formula XI, wherein X′ of the Formula XI of the first α,ω-dihydroxy compound is different than the X′ of the Formula XI of the second α,ω-dihydroxy compound. In some aspects, the X′ of the Formula XI of the first α,ω-dihydroxy compound can be a linear hydrocarbon, and the X′ of the Formula XI of the second α,ω-dihydroxy compound can contain one or more side functional groups. In some aspects, X′ of the Formula XI of the first α,ω-dihydroxy compound has the formula of formula (1), and X′ the Formula XI of the second α,ω-dihydroxy compound has the formula of formula (6), (7), (8), or (9). In some aspects, the first α,ω-dihydroxy compound can be ethylene glycol, 1,3-propanediol, 1,4-butanediol, 1,6-hexanediol, 1,2-cyclohexanediol, 2-butene-1,4-diol, or any combinations thereof. In some aspects, the second α,ω-dihydroxy compound can be glycerol, trimethalolmethane, trimethalolethane, trimethalolpropane, 3-hydroxymethyl-1,5-pentanediol, pentaerythritol, or any combinations thereof. In some aspects, the a) HO₂C—Z—CO₂H and/or ester thereof, and b) HO₂C—Z′—CO₂H and/or ester thereof can be reacted with i) a first α,ω-dihydroxy compound, and ii) a second α,ω-dihydroxy compound at i) a temperature of 90 to 250° C., and/or ii) under inert atmosphere and/or vacuum.

Certain aspects are directed to a method for recycling a copolymer described herein. In some aspects, the recycling method can include depolymerization of the copolymer. In some aspects, the copolymer can be contacted water and/or an alcohol under conditions suitable to depolymerize the copolymer to produce i) a first α,ω-carboxylic acid compound having a formula of HOOC—Z—COOH and/or an ester thereof, ii) a second α,ω-carboxylic acid compound having a formula of HOOC—Z′—COOH and/or an ester thereof, and iii) a compound of Formula XI. The polymer can get depolymerized through hydrolysis (e.g. with water) and/or alcoholysis (e.g. with alcohol). In certain aspects, the polymer can be depolymerized by contacting the polymer with methanol. In certain aspects, the depolymerization conditions can include a temperature of 100° C. to 250° C. and/or a pressure of 10 barg to 60 barg.

In some aspects, the copolymer can be depolymerized to obtain a first α,ω-carboxylic acid compound having a formula of HOOC—Z—COOH and/or an ester thereof, ii) a second α,ω-carboxylic acid compound having a formula of HOOC—Z′—COOH and/or an ester thereof, iii) a first α,ω-dihydroxy compound having the formula of Formula XI, and ii) a second α,ω-dihydroxy compound having the formula of Formula XI. The first α,ω-dihydroxy compound and ii) the second α,ω-dihydroxy compound can be as described above.

In certain aspects, the first and second recycled α,ω-carboxylic acid compounds obtained (e.g., through depolymerization) can be repolymerized to form a copolymer described herein. In certain aspects, the first and second recycled α,ω-carboxylic acid compounds obtained (e.g., through depolymerization) can be repolymerized with a compound of Formula XI. α,ω-dihydroxy compounds formed from depolymerization can be same or different that α,ω-dihydroxy compounds used for repolymerization.

Certain aspects are directed to a composition containing a copolymer described herein. In some aspects, the composition can further contain one or more additional components in addition to the copolymer. In some aspects, the composition can be comprised in or in the form of a foam, a fiber, a powder, a film, a layer, or a sheet. Certain aspects are directed to an article of manufacture containing a copolymer described herein and/or a composition containing the copolymer. The composition and/or article of manufacture can be molded, such as extruded, injection molded, blow molded, compression molded, rotational molded, thermoformed and/or 3-D printed article.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to other aspects of the invention. It is contemplated that any embodiment discussed herein can be implemented with respect to any method or composition of the invention, and vice versa. Furthermore, compositions the invention can be used to achieve methods of the invention.

The following includes definitions of various terms and phrases used throughout this specification.

The term “degree of branching (DB)” of a group/oligomer/polymer refers to % of branched carbons in the backbone of the group/oligomer/polymer. For example, the following group having the formula of Formula (16), has a degree of branching 25%. The branched carbons in the backbone of the group of Formula 16 is marked with a *. R′ in formula 16 is a branching group, can be an alkyl group, and r is an integer and denotes number of repeat units.

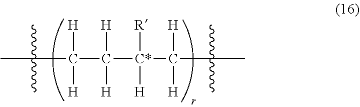

The term “linear hydrocarbon” refers to a hydrocarbon having a continuous carbon chain without side chain branching. The continuous carbon chain may be optionally substituted. The optional substitution can include replacement of at least one hydrogen atom with a functional group, such as hydroxyl, acid, amine, or halogen group; and/or replacement of at least one carbon atom with a heteroatom.

The term “branched hydrocarbon” refers to a hydrocarbon having a linear carbon chain containing branches, such as substituted and/or unsubstituted hydrocarbyl branches, bonded to the linear carbon chain. Optionally, the linear carbon chain can contain additional substitution. Optional additional substitutions can include replacement of at least one carbon atom in the linear carbon chain with a heteroatom and/or replacement of at least one hydrogen atom directly bonded to a carbon atom of the linear chain with a functional group, such hydroxyl, acid, amine, or halogen group.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %,” “vol. %,” or “mol. %” refers to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The polymer the present invention can “comprise,” “consist(s) essentially of,” or “consist of” particular groups, compositions, etc. disclosed throughout the specification. In one aspect of the present invention, and with reference to the transitional phrase “consist(s) essentially of” or “consisting essentially of,” a basic and novel characteristic of the present invention can include the copolymer containing repeating units of Formula I and repeating units of Formula II and/or can be chemically recycled to its building blocks or monomeric units in a relatively efficient manner (e.g., contacted with aqueous and/or alcohol solutions).

All publications mentioned herein are incorporated herein by reference to disclose and describe the methods and/or materials in connection with which the publications are cited.

Other objects, features and advantages of the present invention will become apparent from the following detailed description and examples. It should be understood, however, that the detailed description and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

In the context of the present invention, at least the following 23 aspects are described. Aspect 1 is directed to a copolymer comprising repeating units of Formula I, and repeating units of Formula II,

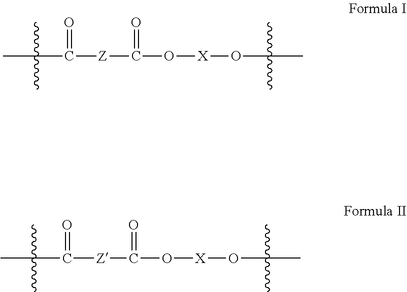

wherein,
X is an aliphatic group for each of Formula I and II;
Z is a first polyolefin group comprising at least 45 carbon atoms, preferably 45 to 1,000 carbon atoms, and has a degree of saturation 98 to 100%; and
Z′ is a an aliphatic group,
wherein, the structure of Z is different than Z′.

Aspect 2 is directed to the copolymer of aspect 1, wherein Z and Z′ independently has a degree of branching (DB) of 0 to 50%.

Aspect 3 is directed to the copolymer of any one of aspects 1 to 2, wherein Z and/or Z′ independently comprises branches having independently 1 to 10 carbons.

Aspect 4 is directed to the copolymer of any one of aspects 1 to 3, wherein Z has a DB of 0 to less than 5% and Z′ has a DB of 5 to 50%.

Aspect 5 is directed to the copolymer of any one of aspects 1 to 4, wherein Z and/or Z′ are independently polyethylene, polypropylene, poly(ethylene-co-propylene), poly(ethylene-co-1-butene), poly(ethylene-co-1-hexene), or poly(ethylene-co-1-octene) group.

Aspect 6 is directed to the copolymer of any one of aspects 1 to 5, wherein Z and/or Z′ are independently an atactic, isotactic, or syndiotactic polypropylene.

Aspect 7 is directed to the copolymer of any one of aspects 1 to 6, wherein X for each of Formula I and II is independently

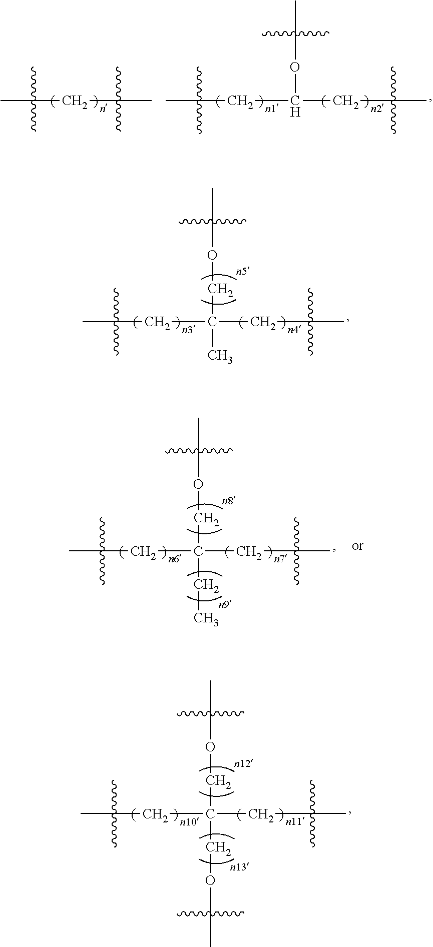

combination thereof,
wherein n′ is an integer from 1 to 15, and n1′, n2′, n3′, n4′, n5′, n6′, n7′, n8′, n9′, n10′, n11′, n12′, and n13′, are independently an integer from 1 to 10.

Aspect 8 is directed to the copolymer of aspect 1, comprising repeating units of Formula III, and repeating units of Formula IV,

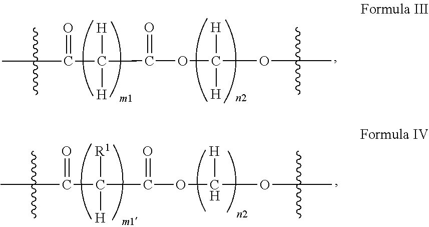

wherein n2 is independently an integer from 0 to 15, and preferably from 1 to 15, for each of Formulas III and IV, and denotes number of repeat units,
m1 is an integer from 45 to 1000, and denotes number of repeat units,
m1′ is an integer from 45 to 1000, and denotes number of repeat units,
R¹ is —H or —CH₂CH₃, and varies independently between —H and —CH₂CH₃ in the repeating units —CHR¹—, and
the —(CHR¹)_{m1′}— group has a DB of 5 to 50%.

Aspect 9 is directed to the copolymer of aspect 1, comprising repeating units of Formula V, and repeating units of Formula VI,

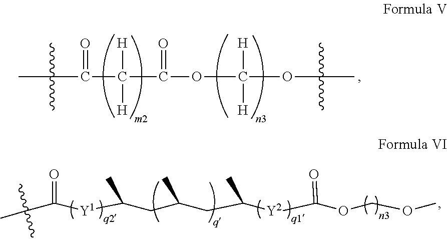

wherein n3 independently is an integer from 0 to 15, and preferably from 1 to 15, for each of Formulas V and VI, and denotes number of repeat units, m2 is an integer from 60 to 600, and denotes number of repeat units, and q′ is an integer from 100 to 225, and denotes number of repeat units.

Aspect 10 is directed to the copolymer of aspect 1, comprising repeating units of Formula VII, and repeating units of Formula VIII,

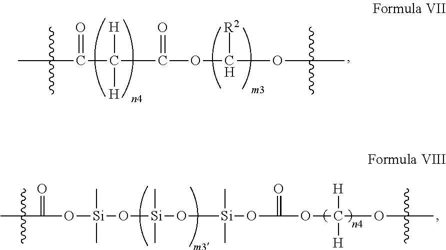

wherein n4 is independently an integer from 0 to 15, and preferably from 1 to 15, for each of Formulas VII and VIII, and denotes number of repeat units,
R² is —H or —CH₂CH₃, and varies independently between —H and —CH₂CH₃ in the repeating units —CHR²—,
the —(CHR²)ₘ₃— group has a DB of 0.01 to 50%,
m3 is an integer from 60 to 600, and denotes number of repeat units, and
m3′ is an integer from 1 to 497, and denotes number of repeat units.

Aspect 11 is directed to the copolymer of aspect 1, comprising repeating units of Formula IX, and repeating units of Formula X,

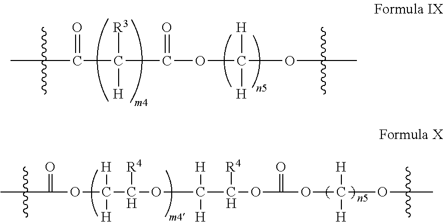

wherein n5 is independently an integer from 0 to 15, and preferably from 1 to 15, for each Formulas IX and X, and denotes number of repeat units,
R³ is —H or —CH₂CH₃, and varies independently between —H and —CH₂CH₃ in the repeating units —CHR³—,
the —(CHR³)ₘ₄— group has a DB of 0.01 to 50%,
m4 is an integer from 60 to 600, and denotes number of repeat units,
m4′ is an integer from 1 to 332, and denotes number of repeat units, and
R⁴ is a C₂ to C₁₀ alkyl group.

Aspect 12 is directed to the copolymer of aspect 1, comprising repeating units of Formula XIV, and repeating units of Formula XV or XVI,

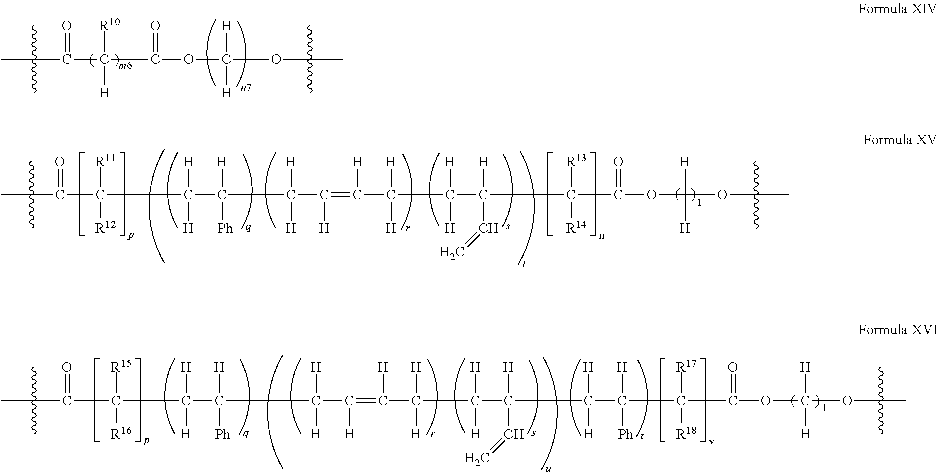

wherein n7 is an integer from 0 to 15, and preferably from 1 to 15, for each of Formula XIV, XV and XVI, and denotes number of repeat units,
m6 is an integer from 60 to 600, and denotes number of repeat units,
R¹⁰ is —H or a C₁ to C₁₀ alkyl group, and can vary independently between H and the C₁ to C₁₀ alkyl group in the repeating units —CHR¹⁰—,
the —(CHR¹⁰)ₘ₆— group has a DB of 0.01 to 50%,
R¹¹ is —H or a C₁ to C₁₀ alkyl group, and can vary independently between —H and the C₁ to C₁₀ alkyl group in the repeating units —CR¹¹R¹²— group,
R¹² can be —H or a C₁ to C₁₀ alkyl group, and can vary independently between —H and the C₁ to C₁₀ alkyl group in the repeating units —CR¹¹R¹²— group,
R³ can be —H or a C₁ to C₁₀ alkyl group, and can vary independently between —H and the C₁ to C₁₀ alkyl group in the repeating units —CR¹³R¹⁴— group,
R¹⁴ can be —H or a C₁ to C₁₀ alkyl group, and can vary independently between —H and the C₁ to C₁₀ alkyl group in the repeating units —CR¹³R¹⁴— group,
R⁵ can be —H or a C₁ to C₁₀ alkyl group, and can vary independently between —H and the C₁ to C₁₀ alkyl group in the repeating units —CR¹⁵R¹⁶— group,
R¹⁶ can be —H or a C₁ to C₁₀ alkyl group, and can vary independently between —H and the C₁ to C₁₀ alkyl group in the repeating units —CR¹⁵R¹⁶— group,
R¹⁷ can be —H or a C₁ to C₁₀ alkyl group, and can vary independently between —H and the C₁ to C₁₀ alkyl group in the repeating units —CR¹⁷R¹⁸— group,
R¹⁸ can be —H or a C₁ to C₁₀ alkyl group, and can vary independently between —H and the C₁ to C₁₀ alkyl group in the repeating units —CR¹⁷R¹⁸— group,
for Formula XV, p and u are independently an integer from 1 to 5; q, r, s, t are independently integers, wherein (q+r/2+s)×2×t≤1000-p-u, and
for Formula XVI, p and v are independently an integer from 1 to 5; q, r, s, t, u are independently integers, wherein (q+(r/2+s)×u+t)×2<1000-p-v.

Aspect 13 is directed to the copolymer of any one of aspects 1 to 12, wherein the copolymer is a statistical copolymer.

Aspect 14 is directed to a method for forming the copolymer of any one of aspects 1 to 13, the method comprising:
reacting i) a first α,ω-dicarboxylic acid compound having a formula of HOOC—Z—COOH and/or an ester thereof and ii) a second α,ω-dicarboxylic acid compound having a formula of HOOC—Z′—COOH and/or an ester thereof, with a α,ω-dihydroxy compound having the chemical formula of Formula XI

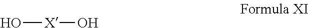

wherein X′ is an aliphatic group.

Aspect 15 is directed to the method of aspect 14, wherein X′ is

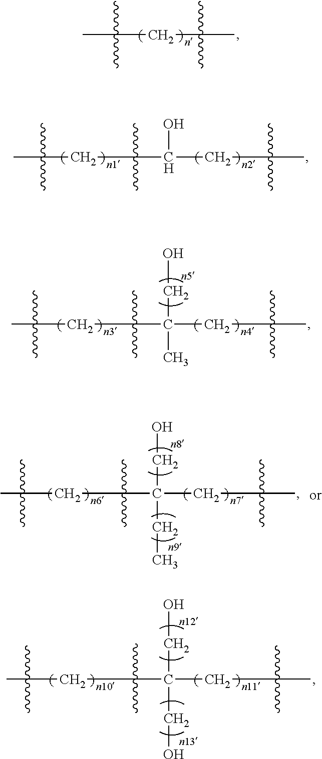

or any combination thereof
wherein n′ is an integer from 1 to 15, and n1′, n2′, n3′, n4′, n5′, n6′, n7′, n8′, n9′, n10′, n11′, n12′, and n13′, are independently an integer from 1 to 10.

Aspect 16 is directed to the method of aspect 14, wherein the α,ω-dihydroxy compound is ethylene glycol, 1,3-propanediol, 1,4-butanediol, 1,6-hexanediol, 1,2-cyclohexanediol, 2-butene-1,4-diol, glycerol, trimethalolmethane, trimethalolethane, trimethalolpropane, 3-hydroxymethyl-1,5-pentanediol, pentaerythritol, or any combinations thereof.

Aspect 17 is directed to the method of any one of aspects 14 to 16, wherein the ester of the acid of HOOC—Z—COOH, and HOOC—Z′—COOH, is independently a methyl, ethyl and/or propyl ester.

Aspect 18 is directed to the method of any one of aspects 14 to 17, wherein the reaction conditions include i) a temperature of 90 to 250° C., and/or ii) inert atmosphere and/or vacuum.

Aspect 19 is directed to a method for recycling a copolymer of any one of claims 1 to 13, the method comprising contacting the polymer with water and/or an alcohol under conditions suitable to depolymerize the polymer through hydrolysis and/or alcoholysis to produce i) a first α,ω-dicarboxylic acid compound having a formula of HOOC—Z—COOH and/or an ester thereof, ii) a second α,ω-dicarboxylic acid compound having a formula of HOOC—Z′—COOH and/or an ester thereof, and iii) a α,ω-dihydroxy compound having the chemical formula of Formula XI

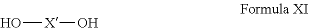

wherein X′ is an aliphatic group.

Aspect 20 is directed to the method of aspect 19, wherein X′ is

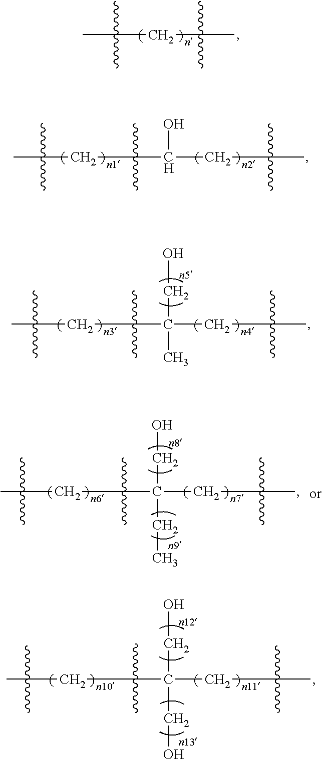

or any combination thereof
wherein n′ is an integer from 1 to 15, and n1′, n2′, n3′, n4′, n5′, n6′, n7′, n8′, n9′, n10′, n11′, n12′, and n13′, are independently an integer from 1 to 10.

Aspect 21 is directed to a composition comprising a copolymer of any one of aspects 1 to 13.

Aspect 22 is directed to the composition of aspect 21, wherein the composition is comprised in an article of manufacture.

Aspect 23 is directed to the composition of aspect 22, wherein the article is an injection molded, blow molded, compression molded, rotational molded, thermoformed and/or 3-D printed article.

### BRIEF DESCRIPTION OF THE DRAWINGS

Advantages of the present invention may become apparent to those skilled in the art with the benefit of the following detailed description and upon reference to the accompanying drawings.

FIG. 1 shows the ¹H-NMR spectra of α,ω-dihydroxy polyethylene.

FIG. 2 shows the Differential scanning calorimetry (DSC) data of α,ω-dihydroxy polyethylene.

FIG. 3 shows the thermal gravimetric analysis (TGA) of α,ω-dihydroxy polyethylene in nitrogen atmosphere.

While the invention is susceptible to various modifications and alternative forms, specific embodiments thereof are shown by way of example in the drawings. The drawings may not be to scale.

### DETAILED DESCRIPTION OF THE INVENTION

A discovery has been made that may provide a solution to at least some of the problems associated with polyolefin polymers. In one aspect, the discovery can include providing a copolymer containing at least one block containing 0.01 to 40 ester groups per 1000 backbone carbons atoms, and having a degree of saturation higher than 97%. The copolymers of the current invention can have polyolefin like properties and can readily be recycled to the monomers of the polymers.

These and other non-limiting aspects of the present invention are discussed in further detail in the following sections.

### A. Copolymer

The copolymer can repeating units of Formula I, and repeating units of Formula II:

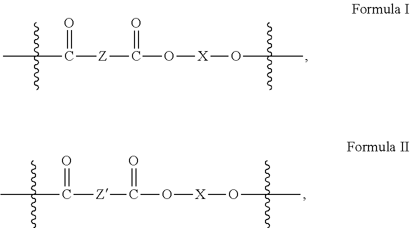

wherein n can independently be 0 or 1 in each of Formulas I and II, and denotes number of repeat units. In some aspects, the copolymer can contain additions units.

Z can be a polyolefin group. In certain aspects, Z can vary randomly between the repeating units of Formula I, such as number of carbon atoms and/or DB of the Z groups in the polymer can vary randomly. In certain aspects, Z does not vary between the repeating units of Formula I. In some aspects, Z can contain at least 45 carbon atoms. In some aspects, the polyolefin group of Z can contain 45 to 1,000, or equal to any one of, at least any one of, or between any two of 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000 carbon atoms; preferably 40 to 800 carbon atoms, more preferably 60 to 600 carbon atoms, most preferably 100 to 700 carbon atoms connecting the two oxygen atoms. In some aspects, average number of carbon atoms in the Z groups of the polymer can be 45 to 1000 or equal to any one of, at least any one of, or between any two of 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000; preferably 40 to 800 carbon atoms, more preferably 60 to 600 carbon atoms, most preferably 100 to 700 carbon atoms connecting the two oxygen atoms. In some aspects, Z can have a degree of saturation 97 to 100%, or equal to any one of, at most any one of, or between any two 97, 97.5, 98, 98.5, 99, 99.5 and 100%. In some aspects, Z can be a linear polyolefin group. In some aspects, Z can be a linear polyolefin groups having the formula of Formula (10)

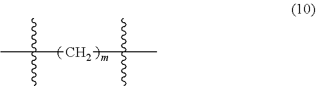 [SMILES: *C*]

where m can be an integer from 45 to 1,000 or equal to any one of, at least any one of, or between any two of 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000, preferably 100 to 700 connecting the two oxygen atoms, and denotes number of repeat units. In some aspects, m can vary randomly between the repeating units of Formula 10, and/or average of m in the polymer, can be 45 to 1,000, or equal to any one of, at least any one of, or between any two of 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000. In some aspects, m does not vary between the repeating units of Formula 10.

In some aspects, Z can be a branched polyolefin having a DB of 0.01 to 50%, or equal to any one of, at most any one of, or between any two 0.01, 0.1, 0.5, 1, 2, 3, 4, 4.5, 5, 6, 7, 8, 9, 10, 15, 20, 25, 30, 35, 40, 45 and 50%. In some aspects, Z can contain C₁ to C₁₀ branches (e.g. on the hydrocarbon backbone). In some aspects, Z can contain C₁ to C₁₀ alkyl group branches. In some aspects, the Z groups in the polymer can have an average DB of 0.01 to 10%, or equal to any one of, at most any one of, or between any two 0.01, 0.1, 0.5, 1, 2, 3, 4, 4.5, 5, 6, 7, 8, 9, 10, 15, 20, 25, 30, 35, 40, 45 and 50%.

In some aspects, Z can be a branched polyolefin group having the formula of Formula (11)

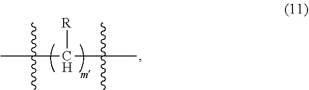

where, m′ can be an integer from 45 to 1000, and R can be —H or a C₁ to C₁₀ alkyl group, and varies independently between H and the C₁ to C₁₀ alkyl group in the repeating units —CHR—, wherein the —(CHR)_{m′}— group has a DB of 0.01 to 50%, or equal to any one of, at most any one of, or between any two of 0.01, 0.1, 1, 2, 3, 4, 4.5, 5, 6, 7, 8, 9, 10, 15, 20, 25, 30, 35, 40, 45 and 50%. In some aspects, m′ can be equal to any one of, at least any one of, or between any two of 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1000. For example, Formula (11a) is a non-limiting example of a polyolefin group with the formula (11), where R is —H or —CH₂CH₃, and R varies independently between —H and the —CH₂CH₃ in the repeating units —CHR—,

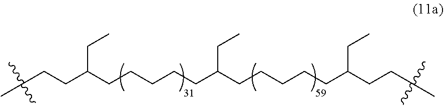

In some aspects, R can be —H or —CH₃. In some aspects, R can be —H or —CH₂CH₃. In some aspects, R can be —H or a C₃ alkyl group. In some aspects, R can be —H or a C₄ alkyl group. In some aspects, R can be —H or a C₅ alkyl group. In some aspects, R can be —H or a C₆ alkyl group. In some aspects, R can be —H or a C₇ alkyl group. In some aspects, R can be —H or a C₈ alkyl group. In some aspects, R can be —H or a C₉ alkyl group. In some aspects, R can be —H or a C₁₀ alkyl group. In some aspects, m′ can vary randomly between the repeating units of Formula 11, and/or average of m's in the polymer can be, 45 to 1,000, or equal to any one of, at least any one of, or between any two of 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000. In some aspects, m′ does not vary between the repeating units of Formula 11. In some aspects, DB of the —(CHR)_{m′}— groups can vary randomly between the repeating units of Formula 11, and/or average DB of the —(CHR)_{m′}— groups in the polymer can be 0.01 to 50%, or equal to any one of, at most any one of, or between any two of 0.01, 0.1, 1, 2, 3, 4, 4.5, 5, 6, 7, 8, 9, 10, 15, 20, 25, 30, 35, 40, 45 and 50%. In some aspects, DB of the —(CHR)_{m′}— group does not vary between the repeating units of Formula 11.

In some aspects, the polyolefin group of Z can be a polyethylene, polypropylene, poly(ethylene-co-propylene), or poly(ethylene-co-α-olefin) group. In some aspects, α-olefin of the poly(ethylene-co-α-olefin) group of Z can independently be a propylene, 1-butene, 4-methyl-1-pentene, 1-hexene, styrene, vinylcyclohexane, 1-octene, norbornene, 5-vinyl-2-norbornene, 5-ethylidene-2-norbornene or 1-decene. In some aspects, Z can be a poly(ethylene-co-α-olefin) group containing less than 5 mol. % of α-olefin. In some aspects, Z can be a poly(ethylene-co-α-olefin) group containing 5 mol. %, or more than 5 mol. % of α-olefin.

The structure of Z can be different than Z′. Z′ can be an aliphatic group. In some aspects, Z′ can have a degree of saturation 97 to 100%, or equal to any one of, at most any one of, or between any two 97, 97.5, 98, 98.5, 99, 99.5 and 100%. In some aspects, Z′ can contain 1 to 1,000 carbon atoms, or equal to any one of, at least any one of, or between any two of 1, 2, 3, 4, 5, 10, 15, 20, 25, 30, 35, 40, 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000 carbon atoms, preferably 100 to 700 carbon atoms connecting the two oxygen atoms. In some aspects, Z′ can have a degree of branching (DB) 0 to 50% or equal to any one of, at least any one of, or between any two of 0, 0.01, 0.1, 1, 3, 4.5, 5, 7, 10, 15, 20, 25, 30, 35, 40, 45 and 50%. In some aspects, Z′ can be a linear hydrocarbon. In some aspects, Z′ can be a branched hydrocarbon. In some aspects, Z′ can be a polyolefin group. In some aspects, Z′ can be a linear polyolefin group. In some aspects, Z′ can be a branched polyolefin group, having a DB of 0.01 to 50%. In some aspects, the branched polyolefin group of Z′ can contain C₁ to C₁₀ hydrocarbon branches. In some aspects, the branched polyolefin group of Z′ can contain C₁ to C₁₀ alkyl group branches. In some aspects, the polyolefin group of Z′ can be a polyethylene, polypropylene, poly(ethylene-co-propylene), or poly(ethylene-co-α-olefin) group. In some aspects, α-olefin of the poly(ethylene-co-α-olefin) group of Z′ can independently be a propylene, 1-butene, 4-methyl-1-pentene, 1-hexene, styrene, vinylcyclohexane, 1-octene, norbornene, 5-vinyl-2-norbornene, 5-ethylidene-2-norbornene or 1-decene. In some aspects, Z′ can be a poly(ethylene-co-α-olefin) group containing less than 5 mol. % of α-olefin. In some aspects, Z′ can be a poly(ethylene-co-α-olefin) group containing 5 mol. %, or more than 5 mol. % of α-olefin. In some aspects, Z′ can be a linear polyethylene group. In some aspects, Z′ can be a branched polyethylene group containing C₁ to C₁₀ alkyl group branches, and a DB of 0.01 to 50%, such as 5 to 50%. In some aspects, Z′ can be an atactic, isotactic, or syndiotactic polypropylene group. In some aspects, Z′ can optionally contain one or more functional side groups. In some aspects, the one or more functional side groups can be one or more hydroxyl, acid, amine, or halogen groups. In some aspects, the functional groups can contain hydrocarbon groups linking the functional group to the hydrocarbon backbone of Z′.

In some aspects, Z and Z′ can be poly(ethylene-co-1-butene) groups where the mol. % of 1-butene in Z and Z′ are different. In some aspects, Z and Z′ can be poly(ethylene-co-1-octene) groups where mol. % of 1-octene in Z and Z′ are different. In some aspects, Z can be a linear or branched polyethylene group, and Z′ can be a poly(ethylene-co-1-butene) group. In some aspects, Z can be a linear or branched polyethylene group, and Z′ can be a poly(ethylene-co-1-octene) group. In some aspects, Z can be a poly(ethylene-co-α-olefin) group, and Z′ can be a polypropylene group.

In some aspects, Z′ can be a polyether group. The polyether group can contain 3 to 1,000 atoms, or equal to any one of, at least any one of, or between any two of 3, 5, 10, 15, 20, 25, 30, 35, 40, 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000 atoms (e.g. carbon and oxygen atoms in total) in the polymer backbone. The polyether can be a linear or a branched polyether. The branched polyether can contain C₁ to C₁₀ hydrocarbon branches. In some aspects, the branched polyether can contain C₁ to C₁₀ alkyl group branches.

In certain aspects, the polyether can have the formula of formula (12)

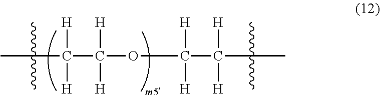

wherein m5′ is an integer from 1 to 332, and denotes number of repeat units. m5′ can be 1, 2, 3, 4, 5, 6, 7, 8, 9, 10, 15, 20, 25, 30, 40, 50, 60, 70, 80, 90, 100, 120, 140, 160, 180, 200, 220, 240, 260, 280, 300, 320, 330, 331, or 332 or any range or integer therein. In some aspects, m5′ can vary randomly between the repeating units of Formula 12, and/or average of m5's in the polymer can be, 1, 2, 3, 4, 5, 6, 7, 8, 9, 10, 15, 20, 25, 30, 40, 50, 60, 70, 80, 90, 100, 120, 140, 160, 180, 200, 220, 240, 260, 280, 300, 320, 330, 331, or 332 or any range or integer therein. In some aspects, m5′ does not vary in the repeating units of Formula 12.

In certain aspects, the polyether can have the formula of formula (13).

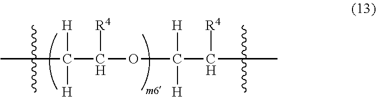

wherein m6′ is an integer from 1 to 332, and denotes number of repeat units. R⁴ can be C₁ to C₁₀ hydrocarbon. m6′ can be 1, 2, 3, 4, 5, 6, 7, 8, 9, 10, 15, 20, 25, 30, 40, 50, 60, 70, 80, 90, 100, 120, 140, 160, 180, 200, 220, 240, 260, 280, 300, 320, 330, 331, or 332 or any range or integer therein. In some aspects, the R⁴ can be —CH₃. In some aspects, R⁴ can be —CH₂CH₃. In some aspects, R⁴ can be a C₃ alkyl. In some aspects, R⁴ can be a C₄ alkyl. In some aspects, R⁴ can be a C₅ alkyl. In some aspects, R⁴ can be a C₆ alkyl. In some aspects, R⁴ can be a C₇ alkyl. In some aspects, R⁴ can be a C₈ alkyl. In some aspects, R⁴ can be a C₉ alkyl. In some aspects, R⁴ can be a C₁₀ alkyl. In some aspects, m6′ can vary randomly between the repeating units of Formula 13, and/or average of m6's in the polymer can be, 1, 2, 3, 4, 5, 6, 7, 8, 9, 10, 15, 20, 25, 30, 40, 50, 60, 70, 80, 90, 100, 120, 140, 160, 180, 200, 220, 240, 260, 280, 300, 320, 330, 331, or 332 or any range or integer therein. In some aspects, m6′ does not vary in the repeating units of Formula 13.

In some aspects, Z′ can be a polydimethylsiloxane group. The polydimethylsiloxane group can contain 3 to 1000 atoms, or equal to any one of, at least any one of, or between any two of 3, 5, 10, 15, 20, 25, 30, 35, 40, 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000 atoms (e.g. silicon and oxygen atoms in total) in the polymer backbone. In some aspects, the polydimethylsiloxane group can have a formula of formula (14)

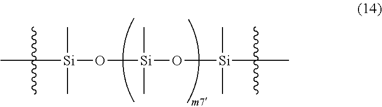

where m7′ is an integer from 1 to 497, or equal to any one of, at least any one of, or an integer between any two of 3, 5, 10, 15, 20, 25, 30, 35, 40, 45, 50, 55, 60, 65, 70, 80, 90, 100, 150, 200, 220, 240, 260, 280, 300, 320, 340, 360, 380, 400, 420, 440, 460, 480, and 497, and denotes number of repeat units. In some aspects, m7′ can vary randomly between the repeating units of Formula 14, and/or average of m7's in the polymer can be, 1 to 497, or equal to any one of, at least any one of, or an integer between any two of 3, 5, 10, 15, 20, 25, 30, 35, 40, 45, 50, 55, 60, 65, 70, 80, 90, 100, 150, 200, 220, 240, 260, 280, 300, 320, 340, 360, 380, 400, 420, 440, 460, 480, and 497. In some aspects, m7′ does not vary in the repeating units of Formula 14.

In some aspects, Z′ can be a polystyrene, polybutadiene or styrene-butadiene copolymer group. In some aspects, Z′ can contain at least 45 carbon atoms, and can have a degree of saturation of the main chain of 60 to 100%, such as 75 to 100%. In some aspects, Z′ can contain 45 to 1,000 carbon atoms, or equal to any one of, at least any one of, or between any two of 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000 carbon atoms. In some aspects, the polyolefin group of Z′ can be a polystyrene, polybutadiene, random poly(styrene-co-butadiene) or poly(styrene-block-polybutadiene) diblock copolymer or poly(styrene-block-polybutadiene-block-styrene) triblock copolymer group.

In some aspects, Z′ is a saturated aliphatic group.

X in each of Formula I and Formula II can independently be an aliphatic group. X in each of Formula I and Formula II can independently contain up to 1000 carbon atoms or equal to any one of, at least any one of, or between any two of 1, 3, 5, 10, 15, 20, 25, 30, 35, 40, 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000 carbon atoms. In certain aspects, X in each of Formula I and Formula II can independently contain 45 to 1000 carbon atoms. In certain aspects, X in each of Formula I and Formula II can independently be a C₁ to C₄₄ aliphatic group. In some particular aspects, X in each of Formula I and Formula II can independently be an aliphatic group containing 1, 2, 3, 4, 5, 6, 7, 8, 9, 10, 11, 12, 13, 14, 15, 16, 17, 18, 19, or 20 carbons. In some aspects, X can be a linear or a branched hydrocarbon. In some aspects, X in each of Formula I and Formula II can independently be a branched hydrocarbon having a DB of 0.01 to 50%, or equal to any one of, at least any one of, or between any two of 0.01, 0.1, 1, 2, 3, 4, 5, 6, 7, 8, 9, 10, 15, 20, 25, 30, 35, 40, 45 and 50%. In some aspects, X in each of Formula I and Formula II can independently be a polyolefin group. In some aspects, X in each of Formula I and Formula II can independently be a linear polyolefin group. In some aspects, X in each of Formula I and Formula II can independently be a branched polyolefin group. In some aspects, X in each of Formula I and Formula II can independently contain C₁ to C₁₀ hydrocarbon branches. In some aspects, X in each of Formula I and Formula II can independently be a polyethylene, poly(ethylene-propylene), poly(α-olefin), poly(α-olefin-co-ethylene), or poly(ethylene-co-α-olefin) group. In certain aspects, X in each of Formula I and Formula II can independently be a poly(ethylene-co-1-butene), poly(ethylene-co-1-hexene), or poly(ethylene-co-1-octene) group. In some aspects, X in each of Formula I and Formula II can independently be a polypropylene group, or a polybutylene group, or a poly(propylene-co-ethylene) group. In some aspects, X in each of Formula I and Formula II can independently be an atactic, isotactic, or syndiotactic polypropylene group. In some aspects, X in each of Formula I and Formula II can independently be random poly(propylene-co-ethylene) group. In some aspects, the one or more side functional groups of X in each of Formula I and Formula II can independently be one or more of oxy, hydroxyl, acid, amine, or halogen groups. In some aspects, the functional groups can contain hydrocarbon groups linking the functional group to the backbone of X. In certain aspects, X can vary randomly between the repeating units of Formula I. In certain aspects, i) number of carbon atoms in the X groups can vary randomly between the repeating units of Formula I or iii) the DB of the X groups can vary randomly between the repeating units of Formula I. In certain aspects, X does not vary between the repeating units of Formula I. In certain aspects, X can vary randomly between the repeating units of Formula II. In certain aspects, i) number of carbon atoms in the X groups can vary randomly between the repeating units of Formula II or iii) the DB of the X groups can vary randomly between the repeating units of Formula II. In certain aspects, X does not vary between the repeating units of Formula II. In some aspects, average of number of carbon atoms in the X groups of the copolymer can be 1 to 1000 or equal to any one of, at least any one of, or between any two of 1, 2, 3, 4, 5, 6, 7, 8, 9, 10, 11, 12, 13, 14, 15, 16, 17, 18, 19, 20, 25, 30, 35, 40, 44, 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000. In some aspects, the X groups in the copolymer can have an average DB of 0.01 to 50%, or equal to any one of, at most any one of, or between any two 0.01, 0.1, 1, 2, 3, 4, 5, 6, 7, 8, 9, 10, 15, 20, 25, 30, 35, 40, 45, and 50%.

In some aspects, X can have the formula of Formula (1), and the copolymer can contain repeating units of Formula Ib, and repeating units of Formula IIb,

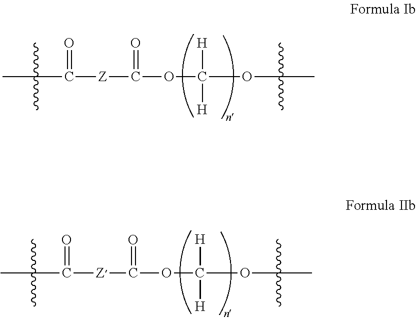

wherein n′ independently can be 1, 2, 3, 4, 5, 6, 7, 8, 9, 10, 11, 12, 13, 14 or 15, for each of Formula Ib and IIb, and denotes number of repeat units.

In some aspects, X can have the formula of Formula (2), and the copolymer can contain repeating units of Formula Ic, and repeating units of Formula IIc,

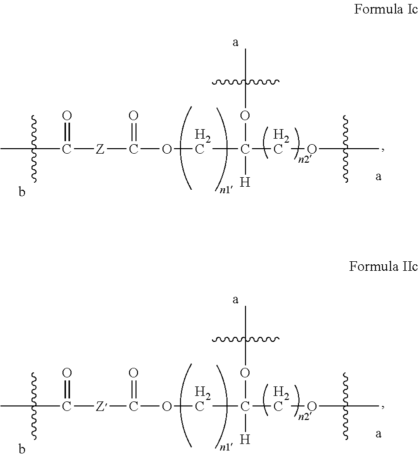

wherein the respective units
are bonded through bonding between “a” and “b” ends, and n1′ and n2′ are independently 1, 2, 3, 4, or 5.

In some aspects, X can have the formula of Formula (3), and the copolymer can contain repeating units of Formula Id, and repeating units of Formula IId,

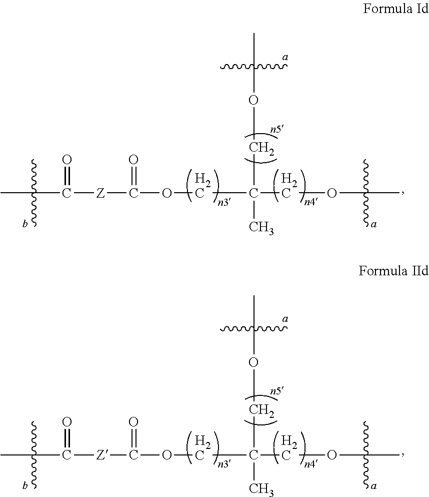

wherein the respective units are bonded through bonding between “a” and “b” ends, and n3′, n4′ and n5′ are independently 1, 2, 3, 4, or 5.

In some aspects, X can have the formula of Formula (4), and the copolymer can contain repeating units of Formula Ie, and repeating units of Formula IIe,

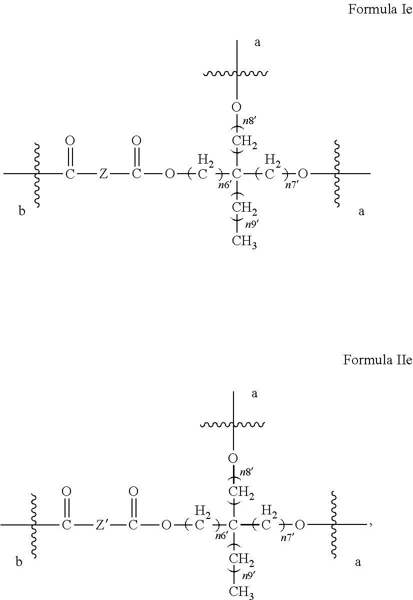

wherein the respective units are bonded through bonding between “a” and “b” ends, and n6′, n7′, n8′ and n9′ are independently 1, 2, 3, 4, or 5.

In some aspects, X can have the formula of Formula (5), and the copolymer can contain repeating units of Formula If, and repeating units of Formula IIf

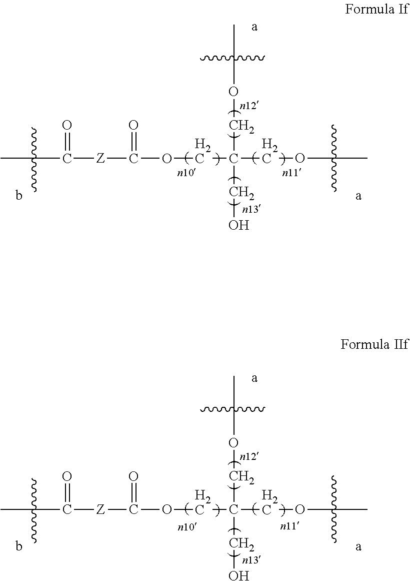

wherein the respective units are bonded through bonding between “a” and “b” ends, and n10′, n11′, n12′, and n13′ are independently 1, 2, 3, 4, or 5.

Formula (1)-(5) are described above.

In certain aspects, the copolymer can contain i) repeating units of a first unit having the formula of Formula I, and ii) repeating units of a second unit having the formula of Formula I, wherein X of the first unit can have a different formula than the X of the second unit. In certain aspects, X of the first unit can be a linear hydrocarbon, and the X of the second unit can contain one or more side functional groups. In some aspects, X of the first unit has the chemical formula of Formula (1), and X of the second unit has the chemical formula of Formula (2), (3), (4) or (5). The Z of the first unit and the second unit can be same or different, e. g. can have same or different chemical formula. In some aspects, Z of the first unit and the second unit can have the same formula. In certain aspects, the ratio of mol. % of the first unit and second unit in the copolymer can be 9:1 to 999:1, or equal to any one of, at least any one of, or between any two of 9:1, 10:1, 15:1, 20:1, 25:1, 30:1, 35:1, 40:1, 45:1, 50:1, 55:1, 60:1, 65:1, 70:1, 75:1, 80:1, 85:1, 90:1, 95:1, 100:1, 200:1, 300:1, 400:1, 500:1, 600:1, 700:1, 800:1, 900:1, and 999:1. In certain aspects, the first unit can have formula of Formula Ib, and the second unit can have formula of Formula Ic, Id, Ie, and/or If.

In certain aspects, the copolymer can contain i) repeating units of a third unit having the formula of Formula II, and ii) repeating units of a fourth unit having the formula of Formula II, wherein X of the third unit can have a different formula than the X of the fourth unit. In certain aspects, X of the third unit can be a linear hydrocarbon, and the X of the fourth unit can contain one or more side functional groups. In some aspects, X of the third unit has the chemical formula of Formula (1), and X of the fourth unit has the chemical formula of Formula (2), (3), (4) or (5). The Z′ of the third unit and the fourth unit can be same or different, e. g. can have same or different chemical formula. In some aspects, Z′ of the third unit and the fourth unit can have the same formula. In certain aspects, the ratio of mol. % of the third unit and fourth unit in the copolymer can be 9:1 to 999:1, or equal to any one of, at least any one of, or between any two of 9:1, 10:1, 15:1, 20:1, 25:1, 30:1, 35:1, 40:1, 45:1, 50:1, 55:1, 60:1, 65:1, 70:1, 75:1, 80:1, 85:1, 90:1, 95:1, 100:1, 200:1, 300:1, 400:1, 500:1, 600:1, 700:1, 800:1, 900:1, and 999:1. In certain aspects, the third unit can have formula of Formula IIb, and the fourth unit can have formula of Formula IIc, IId, IIe, and/or IIf.

In some aspects, Tₘ of the polymer can be 40° C. to 180° C., or equal to any one of, at least any one of, or between any two of 40, 45, 50, 55, 60, 65, 70, 75, 80, 85, 86, 88, 90, 92, 94, 96, 98, 100, 102, 104, 106, 108, 110, 112, 114, 116, 118, 120, 122, 124, 126, 128, 130, 132, 134, 136, 138, 140, 142, 144, 146, 148, 150, 152, 154, 156, 158, 160, 162, 164, 166, 168, 170, 175 and 180° C. In some aspects, the number average molecular weight (Mₙ) of the copolymer can be 10,000 to 1,000,000 g/mol, or equal to any one of, at least any one of, or between any two of 10,000, 20,000, 40,000, 50,000, 60,000, 70,000, 80,000, 90,000, 100,000, 110,000, 120,000, 130,000, 140,000, 150,000, 160,000, 170,000, 180,000, 190,000, 200,000, 250,000, 300,000, 350,000, 400,000, 450,000, 500,000, 550,000, 600,000, 650,000, 700,000, 800,000, 900,000 and 1,000,000 g/mol, as determined as the polyethylene equivalent molecular weight by high temperature size exclusion chromatography performed at 160° C. in trichlorobenzene using polyethylene standards. In some aspects, the copolymer can have a polydispersity index (PDI), of 1.5-4.0, preferably 1.8 to 3.0, or equal to any one of, at least any one of, or between any two of 1, 1.1, 1.2, 1.3, 1.4, 1.5, 1.6, 1.8, 2, 2.2, 2.4, 2.6, 2.8, 3, 3.2, 3.4, 3.6, 3.8, and 4. In some aspects, the copolymer can be a statistical copolymer. In some aspects, the block copolymer can contain at least one amorphous block, and at least one semi-crystalline block. In some aspects, the block copolymer can contain at least two amorphous blocks, wherein the glass transition temperature (T_{g}) of the two blocks can be different.

In some aspects, the Z and Z′ groups in the copolymer can such that melt temperatures (Tₘ) of a polymer, such as a homopolymer, formed by the Z groups of the copolymer, and a polymer, such as a homopolymer, formed by the Z′ groups of the copolymer, can differ by at least 40° C., or by 40° C. to 180° C., such as 85° C. to 170° C., such as 90° C. to 150° C., or equal to any one of, at least any one of, or between any two of 40° C., 50° C., 60° C., 70° C., 80° C., 90° C., 100° C., 110° C., 120° C., 130° C., 140° C., 150° C., 160° C., 170° C., and 180° C. In some aspects, the melt temperatures (Tₘ) of a polymer such as a homopolymer, formed by the Z groups of the copolymer can be greater than can be equal to or greater than 40° C. Tₘ can be measured by differential scanning calorimetry performed at a heating rate of 10° C. per minute and wherein the melting temperature corresponds to the melting peak in the second run. In some aspects, the Z and Z′ groups in the copolymer can such that glass transition temperature (T_{g}) of a polymer, such as a homopolymer, formed by the Z groups of the copolymer, and a polymer, such as a homopolymer, formed by the Z′ groups of the copolymer, can differ by at least 5° C., such as by at least 10° C., such as by at least 20° C., such as by at least 30° C., such as by at least 40° C., such as by at least 50° C., such as by at least 100° C., such as at least by 140° C., or by 10° C. to 140° C., or equal to any one of, at least any one of, or between any two of 10° C., 20° C., 30° C., 40° C., 50° C., 60° C., 70° C., 80° C., 90° C., 100° C., 110° C., 120° C., 130° C., 140° C., 150° C., 160° C., 170° C., and 180° C. In some aspects, the Z and Z′ groups in the copolymer can such that crystallinity at room temperature of a polymer, such as a homopolymer, formed by the Z groups of the copolymer, and a polymer, such as a homopolymer, formed by the Z′ groups of the copolymer, can differ by at least 5%, such as by at least 10%, such as by at least 20%, such as by at least 30%, such as by at least 40%, such as by at least 50%. In certain aspects, a polymer, such as a homopolymer, formed by the Z groups of the copolymer, and the polymer, such as a homopolymer, formed by the Z′ groups of the copolymer can be crystalline at room temperature. In certain aspects, a polymer, such as a homopolymer, formed by the Z groups of the copolymer, and a polymer, such as a homopolymer, formed by the Z′ groups of the copolymer can be amorphous at room temperature. In certain aspects, a polymer, such as a homopolymer, formed by the Z groups of the copolymer can be amorphous, and the polymer, such as a homopolymer, formed by the Z′ groups of the copolymer can be crystalline at room temperature. In certain aspects, a polymer, such as a homopolymer, formed by the Z groups of the copolymer can be crystalline, and a polymer, such as a homopolymer, formed by the Z′ groups of the copolymer can be amorphous at room temperature. Crystallinity can be measured by X-ray powder diffraction (XRD).

### B. Method of Forming the Polymer

Certain aspects are directed to a method for forming a copolymer described herein. The method can include reacting i) a first α,ω-dicarboxylic acid compound having a formula of HOOC—Z—COOH and/or an ester thereof, and ii) a second α,ω-dicarboxylic acid compound having a formula of HOOC—Z′—COOH and/or ester thereof, with a α,ω-dihydroxy compound having a formula of Formula XI,

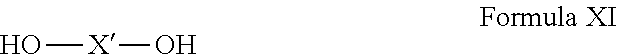

Z and Z′ are as described above.

X′ can be an aliphatic group. X′ can and/or on average contain up to 1000 carbon atoms, or equal to any one of, at most any one of, or between any two of 1, 10, 15, 20, 30, 40, 45, 50, 55, 60, 65, 70, 80, 90, 100, 150, 200, 220, 240, 260, 280, 300, 320, 340, 360, 380, 400, 420, 440, 460, 480, 500, 520, 540, 560, 580, 600, 650, 700, 750, 800, 850, 900, 950, and 1,000 carbon atoms. In certain aspects, X′ can contain 45 to 1000 carbon atoms. In certain aspects, X can be a C₁ to C₄₄ aliphatic group. In some particular aspects, X′ can be an aliphatic group containing 1, 2, 3, 4, 5, 6, 7, 8, 9, 10, 11, 12, 13, 14, 15, 16, 17, 18, 19, or 20 carbons. In some aspects, X′ can be a linear or a branched hydrocarbon. In some aspects, X′ can be a branched hydrocarbon. In some aspects, X′ can be a polyolefin group. In some aspects, X′ can be a linear polyolefin group. In some aspects, X′ can be a branched polyolefin group having a DB of, and/or an average DB of 0.01 to 50%, or equal to any one of, at least any one of, or between any two of 0.01, 0.1, 1, 2, 3, 4, 5, 6, 7, 8, 9, 10, 15, 20, 25, 30, 35, 40, 45 and 50%. In some aspects, X can contain C₁ to C₁₀ hydrocarbon branches. In some aspects, X′ can be a polyethylene, poly(ethylene-propylene), poly(α-olefin), poly(α-olefin-co-ethylene), or poly(ethylene-co-α-olefin) group. In certain aspects, X can be a poly(ethylene-co-1-butene), poly(ethylene-co-1-hexene), or poly(ethylene-co-1-octene) group. In some aspects, X′ can be a polypropylene group, or a polybutylene group, or a poly(propylene-co-ethylene) group. In some aspects, X′ can be an atactic, isotactic, or syndiotactic polypropylene group. In some aspects, X′ can be random poly(propylene-co-ethylene) group. In some aspects, X′ can contain one or more side functional groups. In some aspects, the one or more side functional groups can be one or more of oxy, hydroxyl, acid, amine, or halogen groups. In some aspects, the functional groups can contain hydrocarbon groups linking the functional group to the backbone of X′. In some aspects, X′ can have the formula of formula (1), (6), (7), (8), or (9) or any combination thereof. In some aspects, a combination of acids, with different X′ can be used. In some aspects, acids with different X′ can be used, providing a polymer where X varies, such as carbon atoms and/or DB of X varies, randomly between the repeating units of Formula I, and between the repeating units of Formula II.

In some aspects, the α,ω-dihydroxy compound can be ethylene glycol, 1,3-propanediol, 1,4-butanediol, 1,6-hexanediol, 1,2-cyclohexanediol, 2-butene-1,4-diol, or any combinations thereof. In some aspects, the second α,ω-dihydroxy compound can be glycerol, trimethalolmethane, trimethalolethane, trimethalolpropane, 3-hydroxymethyl-1,5-pentanediol, pentaerythritol, or any combinations thereof. In some aspects, the ester of HOOC—Z—COOH and HOOC—Z′—COOH can independently be methyl, ethyl, propyl and/or tertiary butyl ester. In some aspects, i) the HOOC—Z—COOH and/or ester thereof, and ii) HOOC—Z—COOH and/or ester thereof can be reacted with the HO—X′—OH at i) a temperature of 90 to 250° C., or equal to any one of, at least any one of, or between any two of 90, 100, 110, 120, 130, 140, 150, 160, 170, 180, 190, 200, 210, 220, 230, 240, and 250° C. and/or ii) under inert atmosphere and/or vacuum. In some aspects, the reaction can include esterification at 90 to 250° C., and/or under inert atmosphere, followed by polycondensation at 90 to 250° C., and/or under vacuum, e.g. at pressure below 0.5 mbar, such as below 0.1 mbar, such as around 0.05 mbar. In some aspects, HOOC—Z—COOH can be reacted with HO—X′—OH at a mole ratio of 5:95 to 95:5, or equal to any one of, at least any one of, or between any two of, 5:95, 10:90, 15:85, 20:80, 25:75, 30:70, 35:65, 40:60, 45:55, 50:50, 55:45, 60,:40, 65:35, 70:30, 75:25, 80:20, 85:15, 90:10, and 95:05. In some aspects, HOOC—Z′—COOH can be reacted with HO—X′—OH at a mole ratio of 5:95 to 95:5, or equal to any one of, at least any one of, or between any two of, 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, and 95:05. In some aspects, mole ratio of HOOC—Z—COOH and HOOC—Z′—COOH, during polymerization can be 5:95 to 95:5, or equal to any one of, at least any one of, or between any two of, 5:95, 10:90, 15:85, 20:80, 25:75, 30:70, 35:65, 40:60, 45:55, 50:50, 55:45, 60,:40, 65:35, 70:30, 75:25, 80:20, 85:15, 90:10, and 95:05.

In some aspects, the method can include reacting a) HOOC—Z—COOH and/or ester thereof, and b) HOOC—Z—COOH and/or ester thereof with i) a first α,ω-dihydroxy compound having the formula of Formula XI (and/or an ester, and/or cyclic anhydride thereof), and ii) a second α,ω-dihydroxy compound having the formula of Formula XI (and/or an ester, and/or cyclic anhydride thereof), wherein X′ of the Formula XI of the first α,ω-dihydroxy compound is different than the X′ of the Formula XI of the second α,ω-dihydroxy compound. In some aspects, the X′ of the Formula XI of the first α,ω-dihydroxy compound can be a linear hydrocarbon, and the X′ of the Formula XI of the second α,ω-dihydroxy compound can contain one or more side functional groups. In some aspects, X′ of the Formula XI of the first α,ω-dihydroxy compound has the formula of formula (1), and X′ of the Formula XI of the second α,ω-dihydroxy compound has the formula of formula (6), (7), (8), or (9). In some aspects, the first α,ω-dihydroxy compound can be ethylene glycol, 1,3-propanediol, 1,4-butanediol, 1,6-hexanediol, 1,2-cyclohexanediol, 2-butene-1,4-diol, or any combinations thereof. In some aspects, the second α,ω-dihydroxy compound can be glycerol, trimethalolmethane, trimethalolethane, trimethalolpropane, 3-hydroxymethyl-1,5-pentanediol, pentaerythritol, or any combinations thereof. In some aspects, HOOC—Z—COOH and/or ester thereof, and HOOC—Z—COOH and/or ester thereof with the first α,ω-dihydroxy compound, and the second α,ω-dihydroxy compound at i) a temperature of 90 to 250° C., or equal to any one of, at least any one of, or between any two of 90, 100, 110, 120, 130, 140, 150, 160, 170, 180, 190, 200, 210, 220, 230, 240, and 250° C. and/or ii) under inert atmosphere and/or vacuum. In some aspects, the reaction can include esterification at 90 to 250° C., and/or under inert atmosphere, followed by polycondensation at 90 to 250° C., and/or under vacuum, e.g. at pressure below 0.5 mbarg, such as below 0.1 mbarg, such as around 0.05 mbarg. In some aspects, HOOC—Z—COOH (and/or ester thereof) can be reacted with the first α,ω-dihydroxy compound, at a mole ratio of 5:95 to 95:5, or equal to any one of, at least any one of, or between any two of, 5:95, 10:90, 15:85, 20:80, 25:75, 30:70, 35:65, 40:60, 45:55, 50:50, 55:45, 60,:40, 65:35, 70:30, 75:25, 80:20, 85:15, 90:10, and 95:05. In some aspects, HOOC—Z′—COOH (and/or ester thereod) can be reacted with the first α,ω-dihydroxy compound, at a mole ratio of 5:95 to 95:5, or equal to any one of, at least any one of, or between any two of, 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, and 95:05. In some aspects, mole ratio of HOOC—Z—COOH and HOOC—Z′—COOH, during polymerization can be 5:95 to 95:5, or equal to any one of, at least any one of, or between any two of, 5:95, 10:90, 15:85, 20:80, 25:75, 30:70, 35:65, 40:60, 45:55, 50:50, 55:45, 60,:40, 65:35, 70:30, 75:25, 80:20, 85:15, 90:10, and 95:05. The first α,ω-dihydroxy compound and the second α,ω-dihydroxy compound can be reacted with the HOOC—Z—COOH (and/or ester thereof) and HOOC—Z′—COOH (and/or ester thereof) at a first acid: second acid mole ratio of 9:1 to 999:1, or equal to any one of, at least any one of, or between any two of 9:1, 10:1, 15:1, 20:1, 25:1, 30:1, 35:1, 40:1, 45:1, 50:1, 55:1, 60:1, 65:1, 70:1, 75:1, 80:1, 85:1, 90:1, 95:1, 100:1, 200:1, 300:1, 400:1, 500:1, 600:1, 700:1, 800:1, 900:1, and 999:1. In certain aspects, the compounds HOOC—Z—COOH (and/or ester thereof) and HOOC—Z′—COOH (and/or ester thereof) can be polymerized with more than two selected from ethylene glycol, 1,3-propanediol, 1,4-butanediol, 1,6-hexanediol, 1,2-cyclohexanediol, 2-butene-1,4-diol, glycerol, trimethalolmethane, trimethalolethane, trimethalolpropane, 3-hydroxymethyl-1,5-pentanediol, pentaerythritol, or any combinations thereof.

In some aspects, the α,ω-dihydroxy compound having a formula of Formula XI can be reacted with the first α,ω-dicarboxylic acid compound, and the second α,ω-dicarboxylic acid compound, in presence of a triacid, tetraacid, and/or polyacid (poly>4) and/or esters and/or anhydride thereof. The triacid, tetraacid, and/or polyacid (and/or esters and/or anhydride thereof) can react with the α,ω-dihydroxy compound and form branches in the copolymer. The mol. ratio of i) the first and second α,ω-dicarboxylic acid compound (and/or esters and/or anhydride thereof), and ii) triacid, tetraacid, and/or polyacid (and/or esters and/or anhydride thereof), in the reaction mixture can be 9:1 to 100:1 or equal to any one of, at least any one of, or between any two of 9:1, 10:1, 15:1, 20:1, 25:1, 30:1, 35:1, 40:1, 45:1, 50:1, 55:1, 60:1, 65:1, 70:1, 75:1, 80:1, 85:1, 90:1, 95:1, and 100:1. In some aspects, the triacid, tetraacid, and/or polyacid can be citric acid, aconitic acid, isocitric acid, propane-1,2,3-tricarboxylic acid, pentane-1,3,5-tricarboxylic acid, or any combinations thereof.

In certain aspects the reaction, (e.g., esterification and/or polycondensation) can be performed in presence of a catalyst. In some aspects, catalyst used can include but are not limited to a mineral acid, organic acid, organic base, metallic compound and/or enzymes. In some aspects, the metallic compounds can be a hydrocarbyl, oxide, chloride, carboxylate, alkoxide, aryloxide, amide, salen complex, β-ketiminato complex, or guanidinato complex, of a metal. In some aspects, the metal can be Li, Na, K, Mg, Ca, Sc, Y, lanthanides, Ti, Zr, Zn, Mo, Mₙ, Al, Ga, Bi, Sb, or Sn. In some aspects, the catalyst can be Ti(OiPr)₄, Ti(OBu)₄, Al(OiPr)₃, Sn(2-ethyl-hexanoate)₂, MoO₃, or any combinations thereof. In certain aspects, a combination of catalyst can be used.

A non-limiting general example is provided below.

Copolymer Obtained from a Linear and a Branched Diol with Succinic Acid

The diacids (15) and (16) can be polymerized with ethylene glycol to form the copolymer, containing repeating units of (18) and (19).

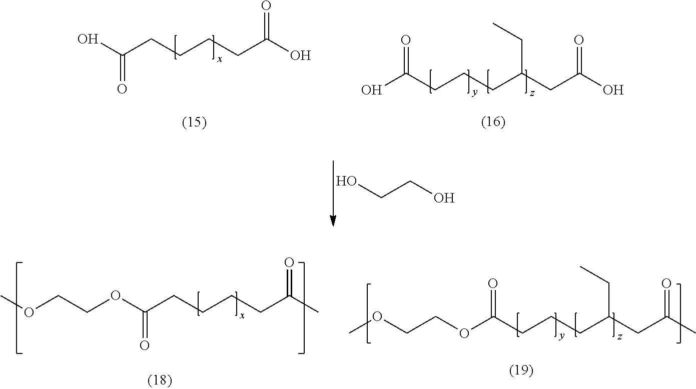

x, y, z are mole fractions. In aspects, x ranges from 1 to 1000, preferably from 1 to 1000, preferably from 20 to 500, and more preferably from 50 to 100, or any range in between, including mentioned endpoints. In aspects, y ranges from 1 to 1000, preferably from 1 to 1000, preferably from 20 to 500, and more preferably from 50 to 100, or any range in between, including mentioned endpoints. In aspects, z ranges from 1 to 100, preferably from 5 to 50, and preferably is 20, or any range in between, including mentioned endpoints. An ethyl group is shown as the branching group, but may be any of a C₁ to C₁₂ moiety, and is preferably an saturated aliphatic group. The polymer (17) can contain units 18 and 19 arranged randomly.

An aspect relates to a copolymer comprising repeating units of Formula I, and repeating units of Formula II,

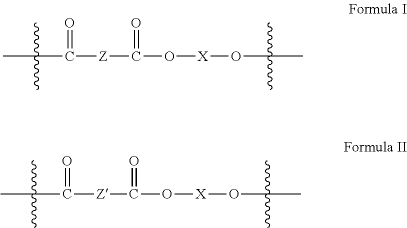

wherein,
X is an aliphatic group for each of Formula I and II;
Z is a first polyolefin group comprising at least 45 carbon atoms, preferably 45 to 1,000 carbon atoms, and has a degree of saturation 98 to 100%; and
Z′ is a an aliphatic group,
wherein the structure of Z is different than Z′, and
wherein Formula I or Formula II, or both, comprise 0.01 to 40 ester groups per 1,000 backbone carbon atoms.

### C. Method of Recycling the Polymer

Certain aspects of the present invention are directed to a method of recycling a copolymer described herein. The recycling can include depolymerizing the copolymer. The copolymer can be depolymerized to obtain a first α,ω-dicarboxylic acid compound having a formula of HOOC—Z—COOH and/or ester thereof, and a second α,ω-dicarboxylic compound having a formula of HOOC—Z′—COOH and/or ester thereof. In certain aspects, the depolymerization method can include hydrolysis and/or alcoholysis of the copolymer to obtain the compound of formula HOOC—Z—COOH (and/or ester thereof), HOOC—Z′—COOH (and/or ester thereof), and/or a compound of Formula XI. In certain aspects, the depolymerization method can include methanolysis of the copolymer under conditions suitable to obtain methyl esters of HOOC—Z—COOH and HOOC—Z′—COOH.

In certain aspects, the depolymerization of the copolymer can produce i) the compound HOOC—Z—COOH (and/or ester thereof), ii) the compound HOOC—Z′—COOH (and/or ester thereof), iii) a first α,ω-dihydroxy compound having a formula of Formula XI, and iv) a second α,ω-dihydroxy compound having the formula of Formula XI, wherein X′ of the Formula XI of the first α,ω-dihydroxy compound is different than the X′ of the Formula XI of the second α,ω-dihydroxy compound. In some aspects, the X′ of the Formula XI of the first α,ω-dihydroxy compound can be a linear hydrocarbon, and the X′ of the Formula XI of the second α,ω-dihydroxy compound can contain one or more side functional groups. In some aspects, X′ of the Formula XI of the first α,ω-dihydroxy compound has the formula of formula (1), and X′ of the second α,ω-dihydroxy compound has the formula of formula (6), (7), (8), or (9).

In some aspects, the first α,ω-dihydroxy compound can be ethylene glycol, 1,3-propanediol, 1,4-butanediol, 1,6-hexanediol, 1,2-cyclohexanediol, 2-butene-1,4-diol, or any combinations thereof. In some aspects, the second α,ω-dihydroxy compound can be glycerol, trimethalolmethane, trimethalolethane, trimethalolpropane, 3-hydroxymethyl-1,5-pentanediol, pentaerythritol, or any combinations thereof. In some aspects, the methanolysis conditions can include i) a temperature of 100° C. to 250° C., or equal to any one of, at least any one of, or between any two of 100, 110, 120, 130, 140, 150, 160, 170, 180, 190, 200, 210, 220, 230, 240, and 250° C. and/or ii) a pressure of 10 barg to 60 barg, or equal to any one of, at least any one of, or between any two of 10, 15, 20, 25, 30, 35, 40, 45, 50, 55 and 60 barg. In some aspects, the depolymerization can be performed at an inert atmosphere. Catalyst used for depolymerization, such as methanolysis can include a mineral acid, organic acid, organic base, and/or metallic compound. In some aspects, the metallic compounds can be a hydrocarbyl, oxide, chloride, carboxylate, alkoxide, aryloxide, amide, salen complex, β-ketiminato complex, or guanidinato complex, of a metal. In some aspects, the metal can be Li, Na, K, Mg, Ca, Sc, Y, lanthanides, Ti, Zr, Zn, Mo, Mₙ, Al, Ga, Bi, Sb, or Sn. In some aspects, the catalyst can be Ti(OiPr)₄, Ti(OBu)₄, Al(OiPr)₃, Sn(2-ethyl-hexanoate)₂, MoO₃, or any combinations thereof.

In certain aspects, the method of recycling can include repolymerization of the recycled HOOC—Z—COOH (and/or ester thereof) and/or HOOC—Z′—COOH (and/or ester thereof), e.g., obtained from the depolymerization process. The recycled HOOC—Z—COOH (and/or ester thereof) and/or HOOC—Z′—COOH (and/or ester thereof), can be repolymerized to form a copolymer described herein. α,ω-dihydroxy compound(s) formed during depolymerization, and α,ω-dihydroxy compound(s) used for repolymerization can be same or different.

### D. Compositions and Article of Manufacture Containing the Polymer

The copolymer described herein can be included in a composition. In some aspects, the composition can contain a blend of the copolymer and one or more other polymers. In some aspects, the one or more other polymers can be polyethylene, polypropylene, EPDM, polystyrene, polyethylene terephthalate, polybutylene terephthalate, p polyvinyl chloride, polyvinyl acetate, ethyl vinyl alcohol (EVOH), ethylene-vinyl acetate (EVA), polymethyl methacrylates, polyacrylates, polycarbonates, polysulphonates, polyurethanes, polyamides, synthetic rubber, bitumen, mineral oils, or any combinations thereof. In some aspects, the composition can further include one or more additives. The one or more additives may include, but are not limited to, a scratch-resistance agent, an antioxidant, a flame retardant, an UV absorber, a photochemical stabilizer, a filler such as glass and/or mineral filler, an optical brightener, a surfactant, a processing aid, a mold release agent, a pigment, flow modifiers, foaming agents or any combinations thereof. In some aspects, the compositions can be comprised in or in the form of a foam, a film, a layer, a sheet, a molded article, a welded article, a filament, a fiber, a wire, a cable, or a powder. In one example, the composition is incorporated into a film. Specifically, the film may include at least one film layer that includes the composition. In further aspects the film includes at least a second film layer.

Certain aspects are directed to an article of manufacture containing a copolymer described herein and/or a composition containing the copolymer. The composition and/or article of manufacture can be molded, such as extruded, injection molded, blow molded, compression molded, rotational molded, thermoformed and/or 3-D printed article. In some aspects, the article of manufacture can be a personal equipment part, an automobile part, plumbing material, construction material, a consumer electronics housing, a personal equipment part, a kitchen appliance, furniture, or a home appliance component.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

Production of olefin block co-polymer mimics (OBC-mimics)

In this example, random olefin block copolymer are synthesized using α,ω-di carboxy polyethylene (90 mol %), α,ω-dicarboxy hydrogenated polybutadiene-20% branching (10 mol %) and ethylene glycol.

Step I—esterification: 8.64 mmol α,ω-dicarboxy polyethylene, 0.96 mmol α,ω-dicarboxy hydrogenated polybutadiene, 12.48 mmol succinic acid and 0.24 g titanium tetra-isopropoxide were introduced into the reactor and the reactor was then heated to 190° C. while stirring and in the presence of a nitrogen atmosphere. The esterification was conducted for 2.5 hrs at atmospheric pressure.

Step II—polycondensation: After Step I polycondensation was started by turning off the nitrogen and gradually reducing the pressure down to approximately 0.05 mbar. The temperature was raised to 220° C. The polycondensation reaction was conducted for 3.0 hrs. At the end of 3 hours, the vacuum was released by bleeding in the nitrogen and the resultant polymer was collected.

A general scheme for this process is shown below, wherein x is 120, y is 20, and z is 211:

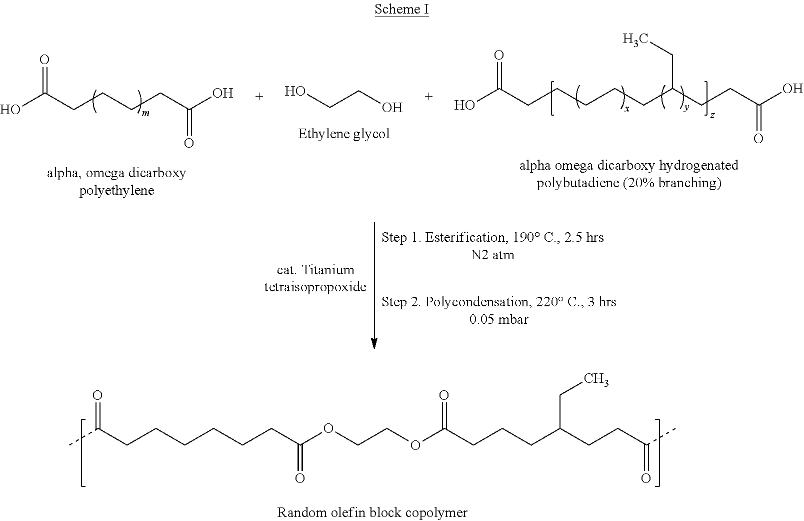

### Example 2

In this example, random olefin block copolymer synthesis using α,ω-dicarboxy polyethylene (40 mol %), α,ω-dicarboxy hydrogenated polybutadiene—20% branching (60 mol %) and ethylene glycol are reacted as follows:
Step 1—esterification: 4.0 mmol α,ω-dicarboxy polyethylene, 6.0 mmol α,ω-dicarboxy hydrogenated polybutadiene 13 mmol ethylene glycol 0.16 g and titanium tetra-isopropoxide were introduced into the reactor and the reactor was then heated to 190° C. while stirring and in the presence of nitrogen atmosphere. The esterification reaction was conducted for 2.5 hrs at atmospheric pressure.
Step II—polycondensation: After Step I, a polycondensation reaction was initiated by turning off the nitrogen and by gradually reducing the pressure down to approximately 0.05 mbar. The temperature was raised to 220° C. and the polycondensation reaction was conducted for 3.0 hrs. After 3 hours the vacuum was released by bleeding in the nitrogen and the polymer thus produced was collected. Scheme 2 below shows the synthesis pathway. In this example, mis 120, x=m, y is 20, and z is 211:

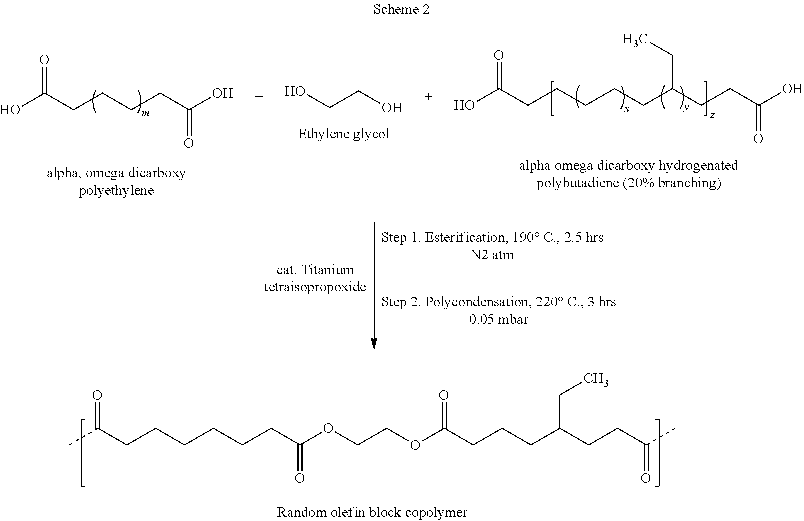

### Example 3

The purpose of this example is to show that elastomeric block copolymers can be created by via polycondensation of a linear polyethylene diol, hydroxyl-terminated polydimethylsiloxane (HO—PDMS-OH).

### Materials

### The following materials were selected to make the

| | | | | | | | Wt %. used |
|---|---|---|---|---|---|---|---|
| | | | | Degree of | Branching | | in the diol |
| | | | | Branching | Carbon | Degree of | part to make |
| Material | Description | Source | Mw | (mol %) | Length | Hydrogenation | the polymer |
| Diol | See synthesis | | 3000 | 0 | 0 | >98% | 80% |
| | below | | | | | | |
| Polydimethyl- | Hydroxyl- | Sigma- | 770 | N/A | N/A | N/A | 20% |
| siloxane | terminated | Aldrich | | | | | |
| Diacid | Succinic | Sigma- | ~118 | 0 | 0 | 100% | N/A |
| | Acid | Aldrich | | | | | |

### Synthesis of Linear Diol MW 3000

### Synthesis of α,ω-Dihydroxy Polyethylene is Shown in Scheme 3

Step 1: cis-1,4-diacetoxy-2-butene (2.07 g, 61 12.0 mmol) was added to THF (135 mL) in a two-neck 500 mL Schlenk flask under argon purging. The flask was then transferred to a 35° C. oil bath, and cis-cyclooctene (30 g, 272.2 63 mmol) was added dropwise over 30 min. The addition of a second generation Grubbs catalyst (101.86 mg, 0.12 mmol) solution in THF (3 mL) was started after adding 1 mL cis cyclooctene. After 6 hours of reaction, the mixture was precipitated into acidic methanol (1.2 L with 35% HCl (1.5 g) solution in water (13.5 g). The precipitated polymer, α,ω-diacetoxy terminated polycyclooctene was collected and dried under vacuum for two days.
Step. 2. To convert the end acetoxy groups in α,ω-diacetoxy terminated polycycloocene into hydroxy groups, the polymer was dissolved in THF (137.5 mL) at 40° C. and 25 wt % NaOMe (2.97 g, 55.0 mmol) solution in methanol was added. The solution was stirred for 20 hours and precipitated into methanol (2 72 L) with 35% HCl (1.5 g) solution in water (13.5 g). The isolated α,ω-dihydroxy polycyclooctene was dried under vacuum.
Step 3. Hydrogenation of α,ω-dihydroxy polycyclooctene (HO—PCOE-OH)HO—PCOE-OH, (10 g, 90.7 mmol double bonds), p-toluenesulfonyl hydrazide (52.4 g, 281.3 mmol), tributylamine (75.6 mL, 317.6 mmol), butylated hydroxytoluene (50 mg, 0.22 mmol), and o-xylene (385.76 mL) were added to a 1000 mL three-neck round-bottom flask. The mixture was heated to 140° C. and refluxed for 6 hours. After cooling to room temperature, the reaction mixture was poured into methanol. The obtained precipitate was washed with methanol (2×500 mL). The isolated white powder was dried under vacuum the extent of hydrogenation was determined by 1H-NMR and found to be >99%. ¹H-NMR of (TCE-d2, ≥99.5 atom % D, 120° C.): δ: 3.66 (t, CH₂—OH, a′); b); 1.61-1.24 (m, —CH₂—). DSC data of α,ω-dihydroxy polyethylene showed a Tₘ and T_{c} of 129° C., 117° C. respectively. TGA in N2 atmosphere was found to be 452° C.

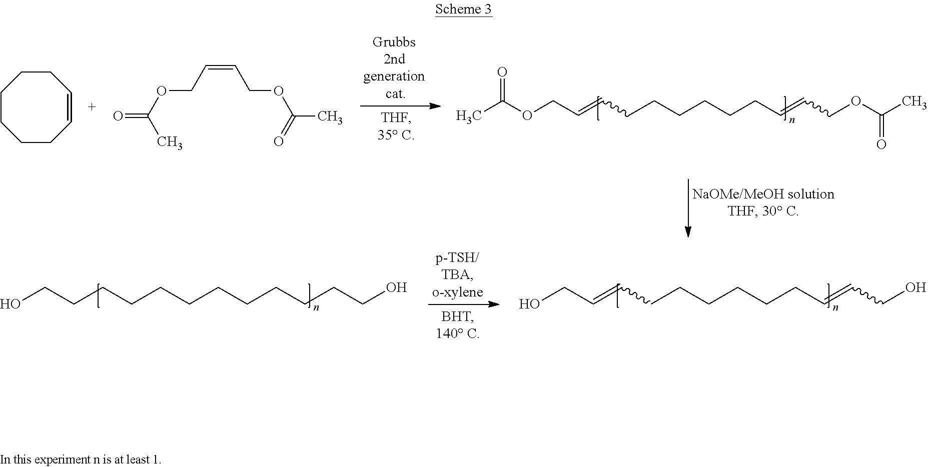

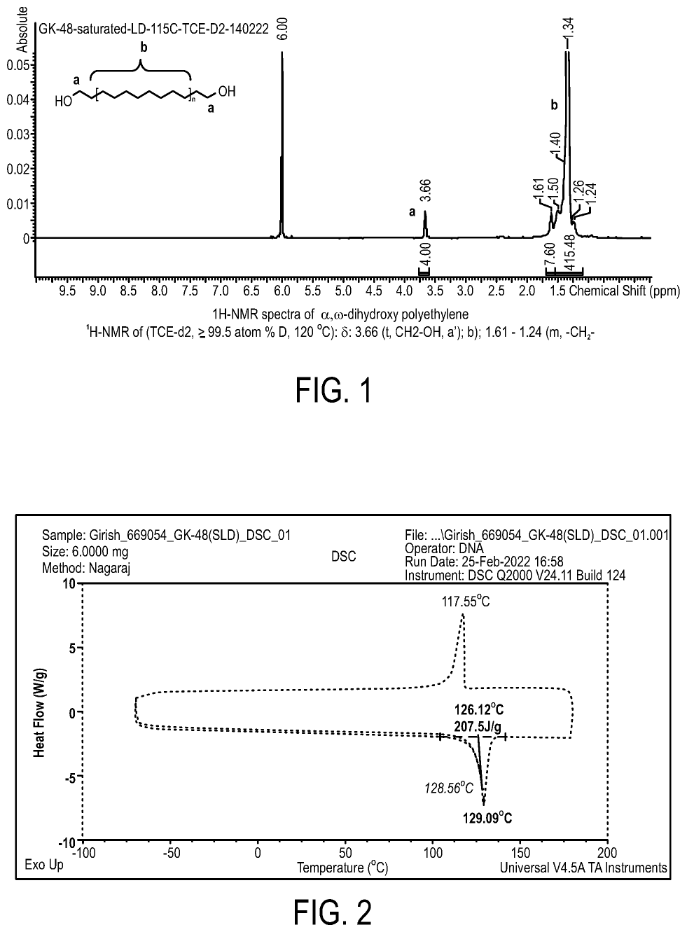

1H-NMR spectra of α,ω-dihydroxy polyethylene is shown in FIG. 1 (1H-NMR of (TCE-d2, ≥99.5 atom % D, 120° C.): δ: 3.66 (t, CH₂—OH, a′); b); 1.61-1.24 (m, —CH2-)

DSC data of α,ω-dihydroxy polyethylene showed a Tm and Tc of 129° C., 117° C. respectively, as is shown in FIG. 2.

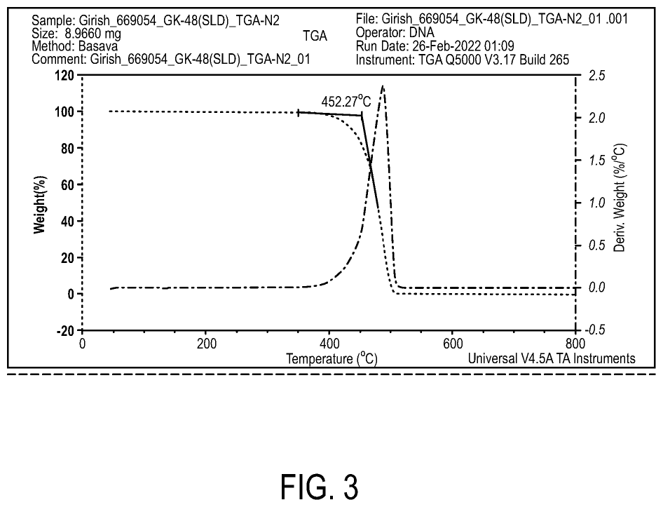

TGA in nitrogen atmosphere was found to be 452° C. as shown in FIG. 3.

### Example 4

### Step 1: Hydrogenation of Unsaturated OH—PB—OH

### Hydrogenation Procedure

Hydrogenation of α,ω-dihydroxy polycyclooctene (HO—PCOE-OH):

HO—PCOE-OH, (10 g, 90.7 m·mol double bonds), p-toluenesulfonyl hydrazide (52.4 g, 281.3 mmol), tributylamine (75.6 mL, 317.6 mmol), butylated hydroxytoluene (50 mg, 0.22 mmol), and o-xylene (385.76 mL) were added to a 1000 mL three-neck round-bottom flask. The mixture was heated to 140° C. and refluxed for 6 hours. After cooling to room temperature, the reaction mixture was poured into methanol. The obtained precipitate was washed with methanol (2×500 mL). The isolated white powder was dried under vacuum the extent of hydrogenation was determined by ¹H-NMR and found to be >99%. ¹H-NMR of (TCE-d2, ≥99.5 atom % D, 120° C.): δ: 3.66 (t, CH₂—OH, a′); b); 1.61-1.24 (m, —CH₂—). DSC data of α,ω-dihydroxy polyethylene showed a Tₘ and T_{c} of 129° C., 117° C. respectively. TGA in N2 atmosphere was found to be 452° C.

The procedure of Example 3 was followed to prepare the diol, and the hydrogenation procedure was used to hydrogenate diol (Mw-3000) to >99.5%.

In a 600 mL Parr vessel, 24 grams of the hydrogenated diol (Mw-3000) was transferred into a conical flask and 150 ml of cyclohexane was added. The contents of the conical flask were mixed thoroughly and then transferred into the Parr vessel. An additional 150 ml of cyclohexane was added into conical flask. The contents of the conical flask was mixed thoroughly and then transferred into the Parr vessel, and a check was made to ensure that no reactant is present in the conical flask. 2.4 grams of 3 wt. % Pd/CaCO₃ catalyst was directly added into the Parr vessel.

α,ω-dihydroxy polydimethylsiloxane:—Commercially available from Gelest Inc. (USA)

### Esterification and Condensation

A random olefin block copolymer synthesis was performed using α,ω-dihydroxy polyethylene (90 mol % ethylene), α,ω-dihydroxy polydimethyl siloxane (10 mol % siloxane) and succinic acid (MW 118, Aldrich) is shown in Scheme V below.

α,ω-dihydroxy polyethylene (8.64 mmol), α,ω-dihydroxy polydimethyl siloxane (0.96 mmol), succinic acid (9.6 mmol), and titanium tetra-isopropoxide (1.34 wt %) were introduced into the reactor and the reactor was then heated to 190° C. under stirring and in the presence of a nitrogen atmosphere. The first stage, esterification was carried out for 2.5 hrs at atmospheric pressure. After that, a second stage, polycondensation was initiated by turning off the nitrogen and by gradually reducing the pressure down to ˜0.05 mbar and the temperature was raised to 220° C. After polycondensation reaction for 3.0 hrs, the vacuum was released by bleeding in the nitrogen and the polymer was collected. In this example, R¹ is ethyl, n is 10, p is 211, q 12, a=1, x=90.

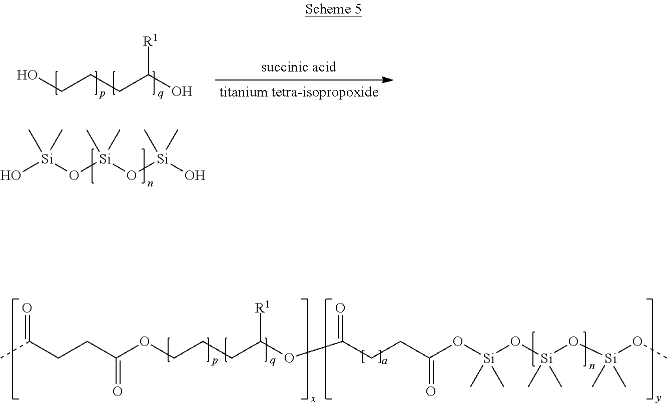

### Results and Discussion

The linear PE diol has a Tg of −100° C., while the PDMS-diol has a Tg of −127° C. Using the Flory-Fox model, for a polymer made with polycondensation of a mixed diol and succinic acid, wherein the mixed diol consists of 80% wt PE-diol and 20% wt. PDMS-diol, the resultant Tg would be −112° C. In other words, assuming the Tₘ of the linear PE-diol to be 118 C, addition of 20% wt. PDMS-diol increases the Tₘ-Tg difference from 218° C. to 230° C., which results in improved-low temperature impact.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

What is claimed is:

1. A copolymer comprising repeating units of Formula I, and repeating units of Formula II, 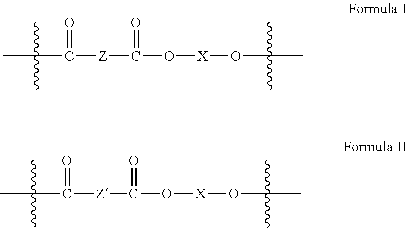
wherein,
X is an aliphatic group for each of Formula I and II;
Z is a first polyolefin group comprising at least 45 carbon atoms, preferably 45 to 1,000 carbon atoms, and has a degree of saturation 98 to 100%; and
Z′ is a an aliphatic group,
wherein the structure of Z is different than Z′, and
wherein Formula I or Formula II, or both, comprise 0.01 to 40 ester groups per 1,000 backbone carbon atoms.

2. The copolymer of claim 1, wherein Z and Z′ independently has a degree of branching (DB) of 0 to 50%.

3. The copolymer of claim 1, wherein Z and/or Z′ independently comprises branches having independently 1 to 10 carbons.

4. The copolymer of claim 1, wherein Z has a DB of 0 to less than 5% and Z′ has a DB of 5 to 50%.

5. The copolymer of claim 1, wherein Z and/or Z′ are independently polyethylene, polypropylene, poly(ethylene-co-propylene), poly(ethylene-co-1-butene), poly(ethylene-co-1-hexene), or poly(ethylene-co-1-octene) group.

6. The copolymer of claim 1, wherein Z and/or Z′ are independently an atactic, isotactic, or syndiotactic polypropylene.

7. The copolymer of claim 1, wherein X for each of Formula I and II is independently 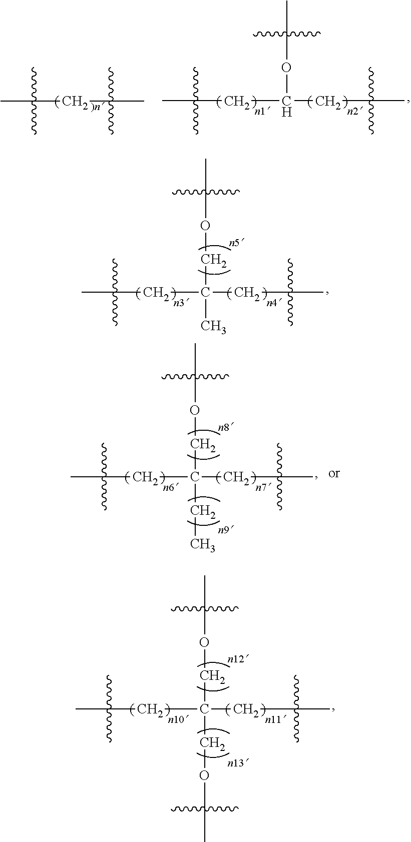
or any combination thereof,
wherein n′ is an integer from 1 to 15, and n1′, n2′, n3′, n4′, n5′, n6′, n7′, n8′, n9′, n10′, n11′, n12′, and n13′, are independently an integer from 1 to 10.

8. The copolymer of claim 1,
i) comprising repeating units of Formula III, and repeating units of Formula IV; or
ii) comprising repeating units of Formula V, and repeating units of Formula VI; or
iii) comprising repeating units of Formula VII, and repeating units of Formula VIII; or
iv) comprising repeating units of Formula IX, and repeating units of Formula X; or
v) comprising repeating units of Formula XIV, and repeating units of Formula XV or XVI,
wherein 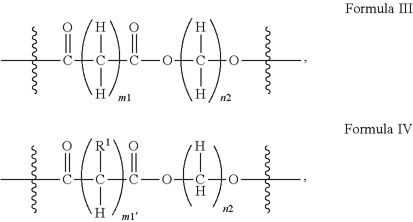
wherein n2 is independently an integer from 1 to 15 for each of Formulas III and IV, and denotes number of repeat units,
m1 is an integer from 45 to 1000, and denotes number of repeat units,
m1′ is an integer from 45 to 1000, and denotes number of repeat units,
R¹ is —H or —CH₂CH₃, and varies independently between —H and —CH₂CH₃ in the repeating units —CHR¹—, and
the —(CHR¹)_{m1′}— group has a DB of 5 to 50%, 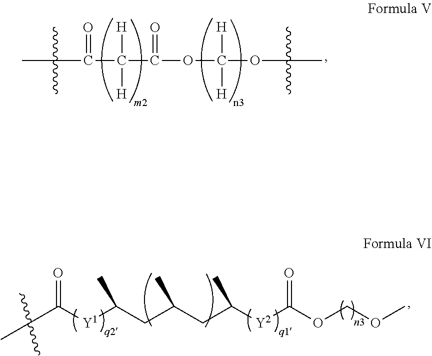
wherein n3 independently is an integer from 0 to 15 for each of Formulas V and VI, and denotes number of repeat units,
m2 is an integer from 60 to 600, and denotes number of repeat units, and
q′ is an integer from 100 to 225, and denotes number of repeat units, 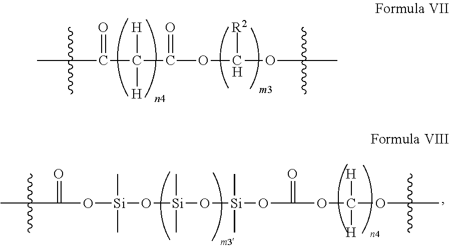
wherein n4 is independently an integer from 0 to 15 for each of Formulas VII and VIII, and denotes number of repeat units,
R² is —H or —CH₂CH₃, and varies independently between —H and —CH₂CH₃ in the repeating units —CHR²—,
the —(CHR²)ₘ₃— group has a DB of 0.01 to 50%,
m3 is an integer from 60 to 600, and denotes number of repeat units, and
m3′ is an integer from 1 to 497, and denotes number of repeat units, 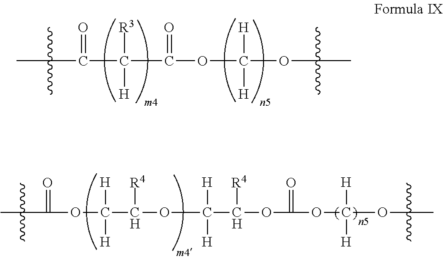
wherein n5 is independently an integer from 0 to 15 for each Formulas IX and X, and denotes number of repeat units,
R³ is —H or —CH₂CH₃, and varies independently between —H and —CH₂CH₃ in the repeating units —CHR³—,
the —(CHR³)ₘ₄— group has a DB of 0.01 to 50%,
m4 is an integer from 60 to 600, and denotes number of repeat units,
m4′ is an integer from 1 to 332, and denotes number of repeat units, and
R⁴ is a C₂ to C₁₀ alkyl group, 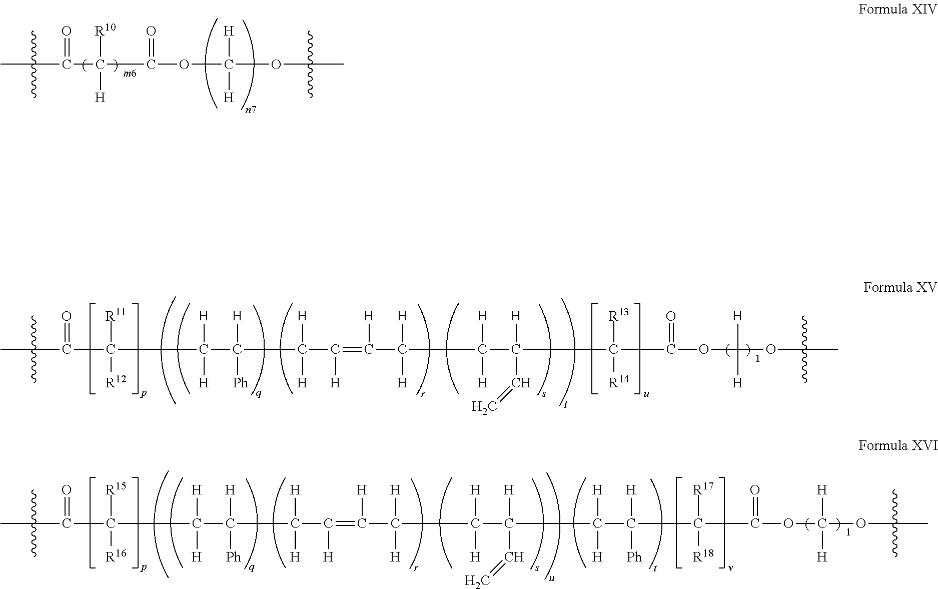
wherein n7 is an integer from 0 to 15 for each of Formula XIV, XV and XVI, and denotes number of repeat units,
m6 is an integer from 60 to 600, and denotes number of repeat units,
R¹⁰ is —H or a C₁ to C₁₀ alkyl group, and can vary independently between H and the C₁ to C₁₀ alkyl group in the repeating units —CHR¹⁰—,
the —(CHR¹⁰)ₘ₆— group has a DB of 0.01 to 50%,
R¹¹ is —H or a C₁ to C₁₀ alkyl group, and can vary independently between —H and the C₁ to C₁₀ alkyl group in the repeating units —CR¹¹R¹²— group,
R¹² can be —H or a C₁ to C₁₀ alkyl group, and can vary independently between —H and the C₁ to C₁₀ alkyl group in the repeating units —CR¹¹R¹²— group,
R¹³ can be —H or a C₁ to C₁₀ alkyl group, and can vary independently between —H and the C₁ to C₁₀ alkyl group in the repeating units —CR¹³R¹⁴— group,
R¹⁴ can be —H or a C₁ to C₁₀ alkyl group, and can vary independently between —H and the C₁ to C₁₀ alkyl group in the repeating units —CR¹³R¹⁴— group,
R¹⁵ can be —H or a C₁ to C₁₀ alkyl group, and can vary independently between —H and the C₁ to C₁₀ alkyl group in the repeating units —CR¹⁵R¹⁶— group,
R¹⁶ can be —H or a C₁ to C₁₀ alkyl group, and can vary independently between —H and the C₁ to C₁₀ alkyl group in the repeating units —CR¹⁵R¹⁶— group,
R¹⁷ can be —H or a C₁ to C₁₀ alkyl group, and can vary independently between —H and the C₁ to C₁₀ alkyl group in the repeating units —CR¹⁷R¹⁸— group,
R¹⁸ can be —H or a C₁ to C₁₀ alkyl group, and can vary independently between —H and the C₁ to C₁₀ alkyl group in the repeating units —CR¹⁷R¹⁸— group,
for Formula XV, p and u are independently an integer from 1 to 5; q, r, s, t are independently integers, wherein (q+r/2+s)×2×t≤1000-p-u, and
for Formula XVI, p and v are independently an integer from 1 to 5; q, r, s, t, u are independently integers, wherein (q+(r/2+s)×u+t)×2<1000-p-v.

9. The copolymer of claim 1, wherein the copolymer is a statistical copolymer.

10. A method for forming the copolymer of claim 1, the method comprising:
reacting i) a first α,ω-dicarboxylic acid compound having a formula of HOOC—Z—COOH and/or an ester thereof and ii) a second α,ω-dicarboxylic acid compound having a formula of HOOC—Z′—COOH and/or an ester thereof, with a α,ω-dihydroxy compound having the chemical formula of Formula XI 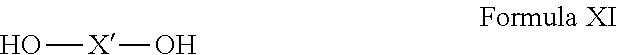
wherein X′ is an aliphatic group.

11. The method of claim 10, wherein X′ is 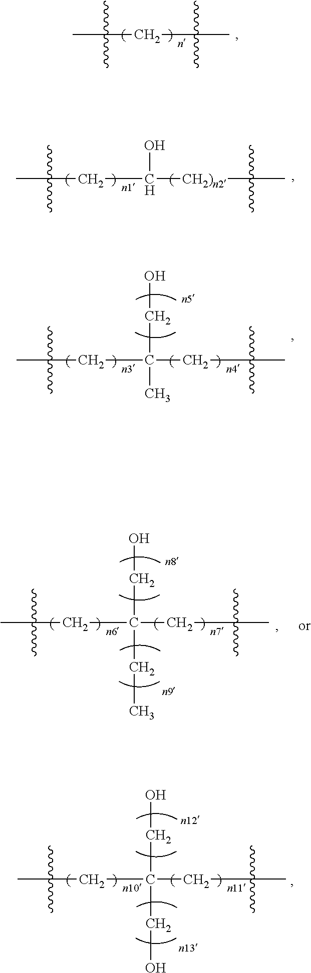
or any combination thereof
wherein n′ is an integer from 1 to 15, and n1′, n2′, n3′, n4′, n5′, n6′, n7′, n8′, n9′, n10′, n11′, n12′, and n13′, are independently an integer from 1 to 10.

12. The method of claim 10, wherein the α,ω-dihydroxy compound is ethylene glycol, 1,3-propanediol, 1,4-butanediol, 1,6-hexanediol, 1,2-cyclohexanediol, 2-butene-1,4-diol, glycerol, trimethalolmethane, trimethalolethane, trimethalolpropane, 3-hydroxymethyl-1,5-pentanediol, pentaerythritol, or any combinations thereof.

13. The method of claim 10, wherein the ester of the acid of HOOC—Z—COOH, and HOOC—Z′—COOH, is independently a methyl, ethyl and/or propyl ester.

14. The method of claim 10, wherein the reaction conditions include i) a temperature of 90 to 250° C., and/or ii) inert atmosphere and/or vacuum.

15. A method for recycling a copolymer of claim 1, the method comprising contacting the polymer with water and/or an alcohol under conditions suitable to depolymerize the polymer through hydrolysis and/or alcoholysis to produce i) a first α,ω-dicarboxylic acid compound having a formula of HOOC—Z—COOH and/or an ester thereof, ii) a second α,ω)-dicarboxylic acid compound having a formula of HOOC—Z′—COOH and/or an ester thereof, and iii) a α,ω-dihydroxy compound having the chemical formula of Formula XI 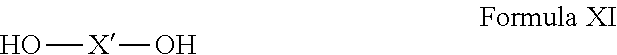
wherein X′ is an aliphatic group, preferably X is 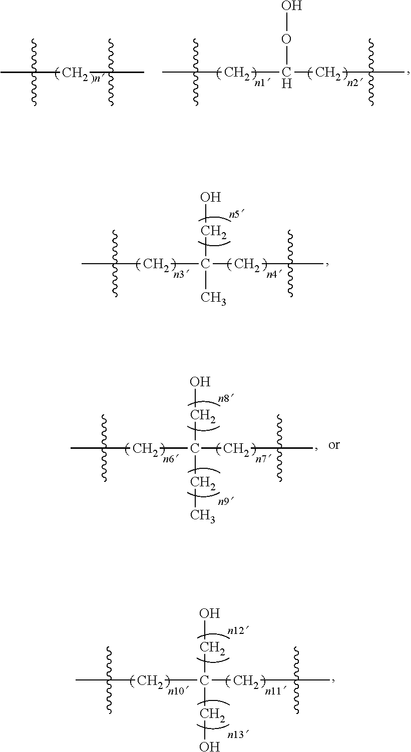
or any combination thereof
wherein n′ is an integer from 1 to 15, and n1′, n2′, n3′, n4′, n5′, n6′, n7′, n8′, n9′, n10′, n11′, n12′, and n13′, are independently an integer from 1 to 10.
